(19) United States
(12) Patent Application Publication
(10) Pub. No.: US 2006/0205594 A1
(43) Pub. Date: Sep. 14, 2006

(54) Heat-sensitive recording material

(75) Inventors: Yasuhiro Mitamura, Shizuoka-ken (JP); Kimi Ikeda, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/346,193

(22) Filed: Feb. 3, 2006

(30) Foreign Application Priority Data
Mar. 14, 2005 (JP) 2005-72061

(51) Int. Cl. B41M 5/20

(52) U.S. Cl. 503/215

(57) ABSTRACT

A leuco color-developing layer contains a microcapsule containing an electron-donating colorless dye-precursor and a mixture of triglycerides, and the particle diameter of the microcapsule is 0.7 to 2.0 μm.

### CROSS-REFERENCE TO RELATED APPLICATION

This application claims priority under 35 USC 119 from Japanese patent Application No. 2005-72061, the disclosure of which is incorporated by reference herein.

### BACKGROUND OF THE INVENTION

1. Field of the Invention

The present invention relates to a heat-sensitive recording material, more particularly, a heat-sensitive recording material having a heat-sensitive recording layer using a vegetable oil.

2. Description of Related Art

Heat-sensitive recording materials are used extensively since they are generally relatively inexpensive, and recording instruments therefor are compact and maintenance-free. In recent years, improvements of the functions of the layers of heat-sensitive recording materials which differ from conventional functions have been requested in particular.

Heat-sensitive recording materials should have favorable imaging performances (e.g., developed color density, image storability, and head matching at recording). Moreover, there are needs for improvement in pre-use storage stability (hereinafter, referred to as “raw storability”), for prevention of staining developed by exposure to light which is a cause for background coloring, for prevention of unpleasant smell, or for achievement of multicolor recording.

Considering the aforementioned requirements, a variety of heat-sensitive recording materials have been proposed (e.g. see Japanese Patent Application Laid-Open (JP-A) No. 2003-127550). In an example, an isocyanate as a capsule-wall forming agent is used for the formation of a microcapsule.

In the constructions described above, various performances such as multicolor recording can be improved to some extent, and the occurrence of offensive smell can be prevented by using a vegetable oil. However, pre-recording storage stability (raw storability) and prevention of stains developed by exposure to light are still insufficient; thus there are demands for further improvements thereof. Since the improvement in raw storability and the prevention of staining caused by exposure to light have an influence on the finally-obtained recorded image, they are essential elements for the formation of a high-quality image other than the improvement in color developing property and the weather resistance of an image.

In addition, prevention of the color mixing is important in the formation of a multicolor image by coloring of a plurality of laminated layers in different hues. In order to prevent the color mixing, it is necessary to adjust the heat sensitivity of each layer adequately while avoiding the energy amount required for coloring the layer that needs the highest heat for coloring being excessively large.

### SUMMARY OF THE INVENTION

The invention has been made in consideration of the problems of the conventional techniques.

The present inventors have found that the use of triglycerides is effective for the improvement of the raw storability of a heat-sensitive recording material that uses a microcapsule containing an electron-donating colorless dye-precursor, and for the prevention of staining upon exposure to light. Based on this finding, the inventors have made the present invention.

The present invention provides a heat-sensitive recording material having one or more heat-sensitive recording layers on a support. At least one of the heat-sensitive recording layer(s) is a leuco color-developing layer that contains a microcapsule containing an electron-donating colorless dye-precursor and a mixture of triglycerides. The particle diameter of the microcapsule is 0.7 to 2.0 μm.

The capsule wall of the microcapsule may contain at least two compounds selected from the group consisting of compound (1), compound (2), and compound (3).

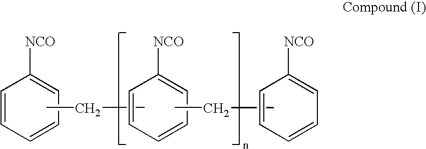

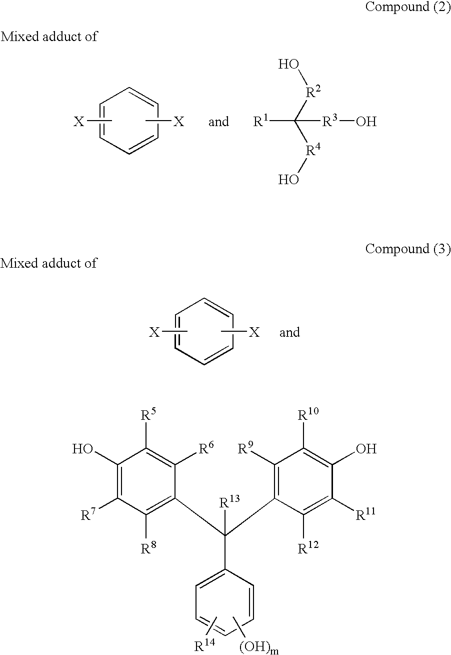

In compound (1), n represents an integer of 0 to 2.

In compound (2), X represents —CH₂—NCO or —NCO, and two Xs may be the same as or different from each other. R¹ represents a hydrogen atom or an alkyl group having 1 to 3 carbon atoms, and R², R³, and R⁴ each independently represent an alkylene group having 1 to 3 carbon atoms.

In compound (3), X represents —CH₂—NCO or —NCO, and two Xs may be the same as or different from each other; R⁵, R⁶, R⁷, R⁸, R⁹, R¹⁰, R¹¹, and R¹² each independently represent a hydrogen atom, a halogen atom, an alkyl group, an alkoxy group, an aryl group, or an aryloxy group; R¹³ represents a hydrogen atom, an alkyl group, or an aryl group; R¹⁴ represents a hydrogen atom, an alkyl group, or an alkoxy group; and m represents an integer of 1 or2.

The mixture of triglycerides may be a mixture of less than 20% by mass of at least one saturated fatty acid having 14 or more carbon atoms, and 20 to 60% by mass of at least one unsaturated fatty acid having 14 or more carbon atoms.

The mixture of triglycerides may be at least one selected from rapeseed oil, sunflower oil, sesame oil, and peanut oil.

The electron-donating colorless dye-precursor may be at least one selected from a dye represented by formula (A) and a dye represented by formula (B).

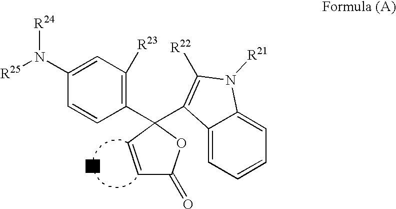

In formula (A), R²¹ represents an alkyl group having 1 to 12 carbon atoms; R²² represents an alkyl group having 1 or 2 carbon atoms; R²³ represents a hydrogen atom, an alkyl group having 1 or 2 carbon atoms, an alkoxy group having 1 to 20 carbon atoms, an aryl group having 6 to 10 carbon atoms, an amido group having 2 to 12 carbon atoms, an alkylsulfonamido group having 1 to 6 carbon atoms, an arylsulfonamido group having 6 to 10 carbon atoms, an anilinocarbonamido group having 7 to 13 carbon atoms, or a halogen atom; R²⁴ and R²⁵ each independently represent an alkyl group having 1 to 8 carbon atoms; and A represents a group which, together with the lactone portion, forms an aromatic ring.

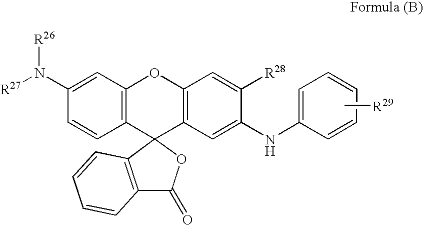

In formula (B), R²⁶ represents an alkyl group having 1 to 4 carbon atoms, R²⁷ represents an alkyl group having 3 to 12 carbon atoms, and R²⁸ and R²⁹ each independently represent a hydrogen atom, a halogen atom, or an alkyl group having 1 to 3 carbon atoms.

In addition to the leuco color-developing layer, the heat-sensitive recording material may further have a diazo color-developing layer containing a diazo compound and a coupler that reacts with the diazo compound under heat to develop color,.

The heat-sensitive recording material may have a plurality of heat-sensitive recording layers which develop colors of respectively different hues selected from yellow, magenta, and cyan, wherein at least one layer of the plurality of heat-sensitive recording layers may be the leuco color-developing layer.

According to the invention, a heat-sensitive recording material which is excellent in raw storability and, at the same time, prevents coloring of a non-image part (background part) caused by staining upon exposure to light can be provided.

### DESCRIPTION OF THE PRESENT INVENTION

The heat-sensitive recording material of the invention will be explained in detail below.

The heat-sensitive recording material of the invention has at least one heat-sensitive recording layer provided on a support. The heat-sensitive recording material may have other layers such as a protecting layer and an intermediate layer as necessary. In a preferable embodiment, the heat-sensitive recording material is a multicolor heat-sensitive recording material having a lamination of a plurality of heat-sensitive recording layers.

At least one heat-sensitive recording layer (hereinafter, also referred to as “leuco color-developing layer according to the invention”) in the heat-sensitive recording material of the invention contains at least a microcapsule containing an electron-donating colorless dye-precursor and a mixture of triglycerides. In general, an electron-receiving compound that color the electron-donating colorless dye-precursor can be present outside the microcapsule. If necessary, other components may also be contained.

-Mixture of Triglycerides-

The leuco color-developing layer according to the invention contains at least one mixture of triglycerides. The mixture of triglycerides contains a vegetable oil, and is used as a solvent for the electron-donating colorless dye-precursor described later. By using the triglycerides, the raw storability can be effectively improved and, at the same time, the background coloring caused by staining upon exposure to light exposure can also be prevented effectively.

In the invention, triglycerides are used, particularly, in the form of a mixture of a plurality of triglycerides. As is already described above, it is generally useful to use a mixture of triglycerides from the viewpoint of the compatibility with the dye, the wall-material monomer, the substance that reduces coloring of an unprinted part after fixing thus improving the fastness of the colored image to light and heat, and the solvent to dissolve them. By the use of the mixture of plural triglycerides, the effects of the invention can be more effectively exerted while the compatibility is secured. The mixture of triglycerides according to the invention is a mixture having a composition in which the proportions of fatty acid components in the total sum of all the molecules (each containing three fatty acid components) is not excessively uneven. Specifically, the mixture preferably satisfies one or more of the following conditions: (i) the three fatty acid components in a compound molecule have two or more different molecular structures, (ii) the structures of the fatty acid components include both a saturated fatty acid and an unsaturated fatty acid, and (iii) there are 3 or more fatty acid species in the whole fatty acid components.

The triglyceride compounds are preferably selected from glyceride compounds of oleic acid, linoleic acid, palmitic acid, myristic acid, linolenic acid, eicosenoic acid, and erucinic acid. Examples of such a mixture of triglycerides include vegetable oils such as sesame oil, safflower oil, soybean oil, sunflower oil, corn oil, cottonseed oil, rapeseed oil, peanut oil, and palm oil.

Among them, the mixture of triglycerides is preferably a mixture containing at least one saturated fatty acid residue having 14 or more carbon atoms (the content of each residue is preferably less than 20% by mass of the total mixture) and at least one unsaturated fatty acid residue having 14 or more carbon atoms (whose amount is preferably 20 to 60% by mass, more preferably 25 to 55% by mass of the total mixture).

Specifically, rapeseed oil, sunflower oil, sesame oil, or peanut oil is preferable. These are preferable in view of production suitability at the formation of a microcapsule comprising a polyurethane polyurea resin obtained by polymerization of a polyvalent isocyanate and a compound having a hydroxy group. They are also preferable in that they are easily available and eco-friendly.

The content of the mixture of triglycerides in the heat-sensitive recording layer is preferably 20 to 130% by mass, more preferably 30 to 120% by mass relative to the electron-donating colorless dye-precursor. When the content is within the aforementioned range, the raw storability can be effectively improved and an image having a high contrast can be formed effectively while suppressing the background coloring.

-Electron-Donating Colorless Dye-Precursor-

The leuco color-developing layer according to the invention contains at least one electron-donating colorless dye-precursor. This electron-donating colorless dye-precursor is a compound that reacts with an electron-receiving compound described later under heat to develop color. When the electron-donating colorless dye-precursor is heated imagewise, color develops to form an image.

The electron-donating colorless dye-precursor can be appropriately selected among known electron-donating colorless dye-precursors which can dissolve in the aforementioned mixture (vegetable oil) of triglycerides used as a solvent. Inter alia, an indolylphthalide compound and an indolylazaphthalide compound are preferable.

In addition, other known dye-precursors can be used together with an indolylphthalide compound or an indolylazaphthalide compound for the purpose of adjusting the hue. Examples thereof include a triarylmethane-based compound, a fluoran-based compound, a phenothiazine-based compound, a rhodaminelactam-based compound, a leucoauramine-based compound, a triazene-based compound, a diphenylmethane-based compound, a xanthene-based compound, and a spiropyran-based compound.

Only one electron-donating colorless dye-precursor may be used, or two or more electron-donating colorless dye-precursors may be used in combination.

Examples of these compounds include 3,3-bis(p-dimethylaminophenyl)-6-dimethylamino phthalide (namely crystal violet lactone), 3,3-bis(p-dimethylamino) phthalide, 3-(p-dimethylaminophenyl)-3-(1,3-dimethylindol-3-yl) phthalide, 3-(p-dimethylaminophenyl)-3-(2-methylindol-3-yl) phthalide, 3-(o-methyl-p-diethylaminophenyl)-3-(2-methylindol-3-yl) phthalide, 4,4′-bis(dimethylamino)benzhydrin benzyl ether, N-halophenyl leucoauramin, N-2,4,5-trichlorophenyl leucoauramin, rhodamin-B-anilinolactam, rhodamin(p-nitroanilino) lactam, rhodamin-B-(p-chloroanilino) lactam, 2-benzylamino-6-diethylaminofluoran, 2-anilino-6-diethylaminofluoran, 2-anilino-3 -methyl-6-diethylaminofluoran, 2-anilino-3 -methyl-6-cyclohexylmethylaminofluoran, 2-anilino-3-methyl-6-isoamylethylaminofluoran, 2-(o-chloroanilino)-6-diethylaminofluoran, 2-octylamino-6-diethylaminofluoran, 2-ethoxyethylamino-3-chloro-2-diethylaminofluoran, 2-anilino-3-chloro-6-diethylaminofluoran, benzoyl leuco methylene blue, p-nitrobenzyl leuco methylene blue, 3-methyl-spiro-dinaphthopyran, 3-ethyl-spiro-dinaphthopyran, 3,3′-dichloro-spiro-dinaphthopyran, 3-benzyl-spiro-dinaphthopyran, and 3-propyl-spiro-dibenzopyran.

In the invention, an electron-donating colorless dye-precursor represented by the following formula (A), and an electron-donating colorless dye-precursor represented by the following formula (B) are preferable. These dye-precursors are preferable in compatibility with triglycerides.

The electron-donating colorless dye-precursor represented by formula (A) or formula (B) will be described in detail below, focusing on explanation of each group.
(Electron-Donating Colorless Dye-precursor Represented by Formula (A))

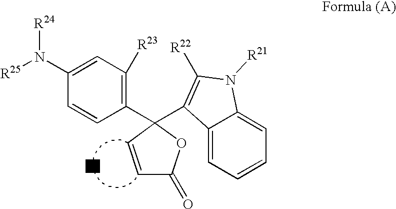

In formula (A), R²¹ represents an alkyl group having 1 to 12 carbon atoms or an aryl group having 6 to 10 carbon atoms.

Examples of the alkyl group having 1 to 12 carbon atoms include a methyl group, an ethyl group, a n-propyl group, an isopropyl group, a n-butyl group, a t-butyl group, a n-pentyl group, a cyclohexyl group, an octyl group, a 2-ethylhexyl group, an isononyl group, and a dodecyl group. Inter alia, a methyl group, an ethyl group, a n-propyl group, a cyclohexyl group, an octyl group, a 2-ethylhexyl group, and an isononyl group are preferable.

Examples of the aryl group having 6 to 10 carbon atoms include a phenyl group, a p-toluyl group, a m-toluyl group, a 2,6-dimethylphenyl group, a 4-t-butylphenyl group, a 4-methoxyphenyl group, a 4-butoxyphenyl group, a 4-methylthiophenyl group, a 3-ethoxy-4-dimethylaminophenyl group, a 2-chlorophenyl group, and a naphthyl group. Inter alia, a phenyl group and a p-toluyl group are preferable.

R²² represents an alkyl group having 1 or 2 carbon atoms, or a phenyl group. Examples of the alkyl group having 1 or 2 carbon atoms represented by R²² include a methyl group and an ethyl group. As R²², a methyl group or a phenyl group is preferable.

R²³ represents a hydrogen atom, an alkyl group having 1 to 12 carbon atoms, an alkoxy group having 1 to 20 carbon atoms, an alkylthio group having 1 to 6 carbon atoms, an aryl group having 6 to 10 carbon atoms, an amido group having 2 to 12 carbon atoms, an alkylsulfonamido group having 1 to 6 carbon atoms, an arylsulfonamido group having 6 to 10 carbon atoms, an anilinocarbonamido group having 7 to 13 carbon atoms, or a halogen atom.

Herein, the definition and preferable range of the alkyl group having 1 to 12 carbon atoms represented by R²³ are the same as those of the alkyl group having 1 to 12 carbon atoms represented by R²¹.

Examples of the alkoxy group having 1 to 20 carbon atoms represented by R²³ include a methoxy group, an ethoxy group, an isopropyloxy group, a sec-butyloxy group, a 3-pentyloxy group, a hexyl group, a cyclohexyl group, an octyloxy group, a 2-ethylhexyloxy group, an isononyloxy group, a dodecyloxy group, a tetradecyloxy group, an octadecyloxy group, and an isooctadecyloxy group. Inter alia, an ethoxy group, an octyloxy group, an isononyloxy group, and an octadecyl group are preferable.

Examples of the alkylthio group having 1 to 6 carbon atoms represented by R²³ include a methylthio group, an ethylthio group, an isopropylthio group, a butylthio group, and a hexylthio group. Inter alia, a methylthio group and an ethylthio group are preferable.

The definition and preferable range of the aryl group having 6 to 10 carbon atoms represented by R²³ are the same as those of the aryl group having 6 to 10 carbon atoms represented by R²¹.

Examples of the amido group having 2 to 12 carbon atoms represented by R²³ include an acetylamido group, a propanoylamido group, an isobutanoylamido group, a pivaloylamido group, a phenylacetylamido group, a diphenylacetylamido group, a benzoylamido group, a cyclohexylcarbonylamido group, a trifluoromethylamido group, a hexanoylamido group, an octanoylamido group, a tetradecyloylamido group, an octadecyloylamido group, a methoxyacetyl group, a phenoxyacetyl group, a 2-(2,4-di-t-butylphenoxy)butanoyl group, a methoxycarbonylamido group, an ethoxycarbonylamido group, a n-propyloxycarbonylamido group, a dimethylaminocarbonylamido group, a n-butylaminocarbonylamido group, an acetylacetylamido group, a benzoylamido group, furoylamido group, and a theoylamido group. Inter alia, an amido group having 2 to 8 carbon atoms is preferable, and an acetylamido group, an isobutanoylamido group, a trifluoromethylamido group, a n-propyloxycarbonylamido group, a dimethylaminocarbonylamido group, a n-butylaminocarbonylamido group, and a theoylamido group are preferable.

Examples of the alkylsulfonamido group having 1 to 6 carbon atoms represented by R²³ include a methylsulfonamido group, an ethylsulfonamido group, and a propylsulfonamido group. Inter alia, a methylsulfonamido group is preferable.

Examples of the arylsulfonamido group having 6 to 10 carbon atoms represented by R²³ include a phenylsulfonamrido group and a toluylsulfonamido group. Inter alia, a phenylsulfonamido group is preferable.

Examples of the anilinocarbonamido group having 7 to 13 carbon atoms represented by R²³ include an anilinocarbonamido group, a 4-methylanilinocarbonamido group, a 4-dimethylaminoanilinocarbonamido group, a N-methyl-anilinocarbonamido group, and a N,N-diphenylaminocarbonamido group. Inter alia, an anilinocarbonamido group is preferable.

Examples of the halogen atom represented by R²³ include a fluorine atom and a chlorine atom.

In formula (A), R²⁴ and R²⁵ each independently represent an alkyl group having 1 to 8 carbon atoms. Examples thereof include a methyl group, an ethyl group, a n-propyl group, an isopropyl group, a n-butyl group, a t-butyl group, a cyclohexyl group, an octyl group, and a 2-ethylhexyl group. Inter alia, a methyl group, an ethyl group, a n-propyl group, a n-butyl group, a cyclohexyl group, and a 2-ethylhexyl group are preferable.

In formula (A), A represents a group which, together with the lactone portion, forms an aromatic ring. Examples thereof include an aryl group and a heterocyclic group. The aryl group may be substituted by an alkoxy group having 1 to 12 carbon atoms or an alkyl-substituted amino group having 2 to 8 carbon atoms. Examples of the heterocyclic residue include a pyridine ring, a pyrimidine ring, and a pyrazine ring. Inter alia, a benzene ring and a pyridine ring are preferable.

Among the foregoing, a particularly preferable electron-donating colorless dye-precursor represented by formula (A) is a compound in which R²¹ is an alkyl group having 1 to 10 carbon atoms, R²² is a methyl group, R²³ is an amido group having 2 to 8 carbon atoms, R²⁴ is an alkyl group having 1 to 5 carbon atoms, R²⁵ is an alkyl group having 1 to 5 carbon atoms, and A is a benzene ring, a benzene ring substituted by an electron-donating group, or a pyridine ring.

Examples of the electron-donating colorless dye-precursor represented by formula (A) are shown below. However, the invention is not limited thereto.

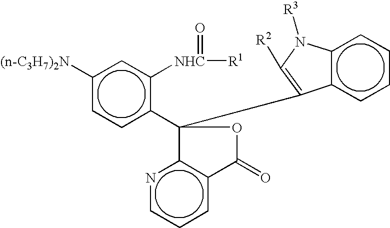

| | R¹ | R² | R³ |
|---|---|---|---|
| i-1 | —CH₃ | —CH₃ | —C₂H₅ |
| i-2 | —C₂H₅ | —CH₃ | —C₂H₅ |
| i-3 | —CH(CH₃)₂ | —CH₃ | —C₂H₅ |
| i-4 | —C(CH₃)₃ | —CH₃ | —C₂H₅ |
| i-5 | 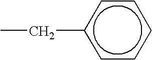 | —CH₃ | —C₂H₅ |
| i-6 | 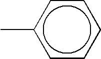 | —CH₃ | —C₂H₅ |
| i-7 | —CH₂OCH₃ | —CH₃ | —C₂H₅ |
| i-8 | —CH₂Cl | —CH₃ | —C₂H₅ |
| i-9 | —CCl₃ | —CH₃ | —C₂H₅ |
| i-10 | —CF₃ | —CH₃ | —C₂H₅ |
| i-11 | 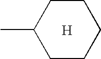 | —CH₃ | —C₂H₅ |
| i-12 | 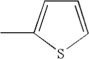 | —CH₃ | —C₂H₅ |
| i-13 | —C₃H₇(n) | —CH₃ | —C₂H₅ |
| i-14 | —CH₃ | —CH₃ | —C₄H₉(n) |
| i-15 | —CH₃ | —CH₃ | —C₈H₁₇(n) |
| i-16 | —CH(CH₃)₂ | —CH₃ | —C₄H₉(n) |
| i-17 | 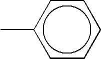 | —CH₃ | —C₅H₁₁(n) |
| i-18 | —CH₂OCH₃ | —CH₃ | —C₈H₁₇(n) |
| i-19 | —CH₃ | —CH₃ | 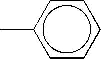 |
| i-20 | 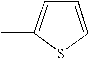 | —CH₃ | —C₆H₁₃(n) |
| i-21 | —CH₃ | 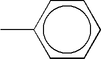 | —C₂H₅ |
| i-22 | —CH₃ | 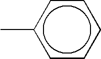 | —C₈H₁₇(n) |
| ia-1 | —C₅H₁₁(n) | —CH₃ | —C₂H₅ |
| ia-2 | —C₇H₁₅(n) | —CH₃ | —C₂H₅ |
| ia-3 | —C₁₇H₃₅(n) | —CH₃ | —C₂H₅ |
| ia-4 | 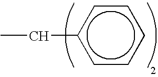 | —CH₃ | —C₂H₅ |
| ia-5 | 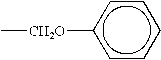 | —CH₃ | —C₂H₅ |
| ia-6 | 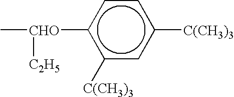 | —CH₃ | —C₂H₅ |
| ia-7 | —CH₃ | —CH₃ | —C₅H₁₁(n) |
| ia-8 | —CH₃ | —CH₃ | —CH(CH₃)₂ |
| ia-9 | —C₃H₇(n) | —CH₃ | —C₈H₁₇(n) |
| ia-10 | —C₄H₉(n) | —CH₃ | —C₈H₁₇(n) |
| ia-11 | —CH(CH₃)₂ | —CH₃ | —C₈H₁₇(n) |
| ia-12 | —C₃H₇(t) | —CH₃ | —C₈H₁₇(n) |
| ia-13 | —C₄H₉(t) | —CH₃ | —C₈H₁₇(n) |
| ia-14 | 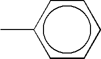 | —CH₃ | —C₈H₁₇(n) |
| ia-15 | 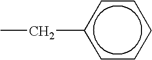 | —CH₃ | —C₈H₁₇(n) |
| ia-16 | 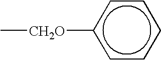 | —CH₃ | —C₈H₁₇(n) |
| ia-17 | —C₃H₇(n) | —CH₃ | 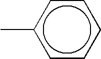 |
| ia-18 | —CH₃ | —CH₃ | 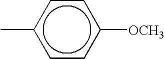 |

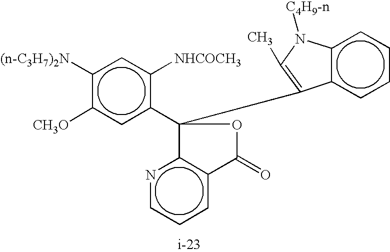

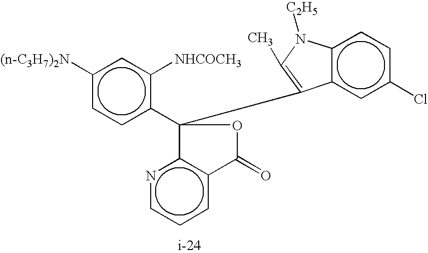

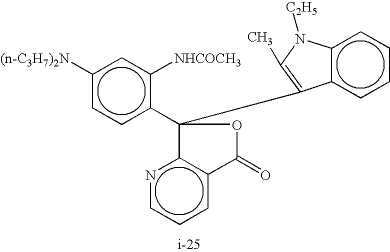

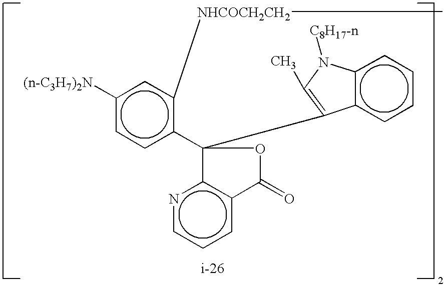

<Electron-Donating Colorless Dye-Precursor Represented by Formula (B)>

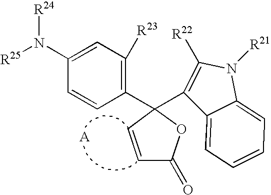

| | R²⁴ | R²⁵ | R²³ | R²² | R²¹ | A |
|---|---|---|---|---|---|---|
| 1-32 | —C₂H₅ | —C₂H₅ | —H | —CH₃ | —C₄H₉(n) | 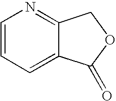 |
| 1-33 | —C₂H₅ | —C₂H₅ | —CH₃ | —CH₃ | —C₂H₅ | 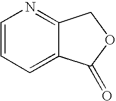 |
| 1-34 | —C₂H₅ | —C₂H₅ | —CH₃ | —CH₃ | —C₈H₁₇(n) | 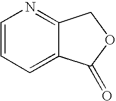 |
| 1-35 | —C₂H₅ | —C₂H₅ | —OC₂H₅ | —CH₃ | —C₂H₅ | 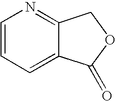 |
| 1-36 | —C₂H₅ | —C₂H₅ | —SC₂H₅ | —CH₃ | —C₂H₅ | 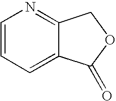 |
| 1-37 | —C₂H₅ | —C₂H₅ | —F | —CH₃ | —C₂H₅ | 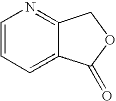 |
| 1-38 | —C₂H₅ | —C₂H₅ | —Cl | —CH₃ | —C₂H₅ | 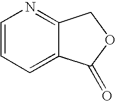 |
| 1-39 | —C₂H₅ | —C₂H₅ | 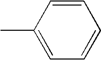 | —CH₃ | —C₂H₅ | 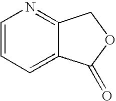 |
| 1-40 | —C₃H₇(n) | —C₃H₇(n) | —NHSO₂CH₃ | —CH₃ | —C₈H₁₇(n) | 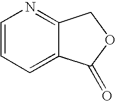 |
| 1-41 | —C₃H₇(n) | —C₃H₇(n) | 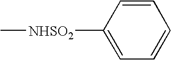 | —CH₃ | —C₈H₁₇(n) | 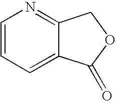 |
| 1-42 | —C₃H₇(n) | —C₃H₇(n) | —NHCO₂C₃H₇(n) | —CH₃ | —C₂H₅ | 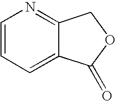 |
| 1-43 | —C₃H₇(n) | —C₃H₇(n) | —NHCO₂CH₃ | —CH₃ | —C₈H₁₇(n) | 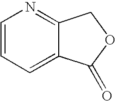 |
| 1-44 | —C₃H₇(n) | —C₃H₇(n) | —NHCONHC₄H₉(n) | —CH₃ | —C₈H₁₇(n) | 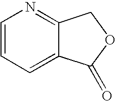 |
| 1-45 | —C₃H₇(n) | —C₃H₇(n) | 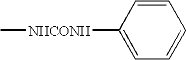 | —CH₃ | —C₈H₁₇(n) | 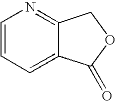 |

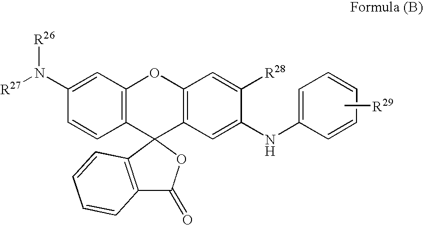

In formula (B), R²⁶ represents an alkyl group having 1 to 8 carbon atoms whose definition and preferable range are the same as those of the alkyl group having 1 to 8 carbon atoms represented by R²⁴ or R²⁵ in formula (A).

R² represents an alkyl group having 3 to 12 carbon atoms, or a tetrahydrofurfuryl group. Examples of the alkyl group having 3 to 12 carbon atoms represented by R²⁷ include a n-propyl group, an isopropyl group, a n-butyl group, an isobutyl group, a hexyl group, an octyl group, a 2-ethylhexyl group, an isononyl group, and a n-dodecyl group. Inter alia, a n-propyl group, an isopropyl group, an isobutyl group, and a n-butyl group are preferable.

R²⁸ and R²⁹ each independently represent a hydrogen atom, a halogen atom, or an alkyl group having 1 to 8 carbon atoms. Preferable examples of the halogen atom represented by R²⁸ or R²⁹ include a fluorine atom and a chlorine atom. The alkyl group having 1 to 8 carbon atoms represented by R²⁸ or R²⁹ has the same definition and preferable range as those of the alkyl group having 1 to 8 carbon atoms represented by R²⁴ or R²⁵ in formula (A).

Among the foregoing, a particularly preferable electron-donating colorless dye-precursor represented by formula (B) is a compound in which R²⁶ is an alkyl group having 1 to 6 carbon atoms, R²⁷ is a tetrahydrofurfuryl group or an alkyl group having 3 to 6 carbon atoms, R²⁸ is an alkyl group having 1 or 2 carbon atoms, R²⁹ is a hydrogen atom or an alkyl group having 1 or 2 carbon atoms.

Examples of the electron-donating colorless dye-precursor represented by formula (B) are shown below. However, the invention is not limited thereto.

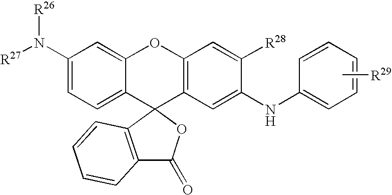

| R²⁶ | R²⁷ | R²⁸ | R²⁹ |
|---|---|---|---|
| —C₂H₅ | —C₂H₅ | —H | —H |
| —C₂H₅ | —C₂H₅ | —CH₃ | —H |
| —CH₃ | —C₃H₇ | —CH₃ | —H |
| —CH₃ | 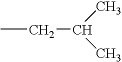 | —CH₃ | —H |
| —C₂H₅ | 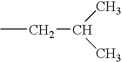 | —CH₃ | —H |
| —C₂H₅ | 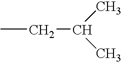 | —CH₃ | —H |
| —C₃H₇ | 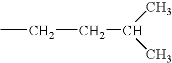 | —CH₃ | —H |
| —C₂H₅ | 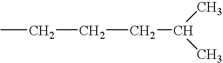 | —CH₃ | -(2-CH₃) |
| —C₂H₅ | 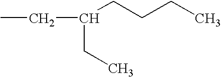 | —CH₃ | —H |
| —C₂H₅ | 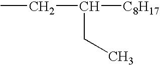 | —CH₃ | —H |
| —C₂H₅ | 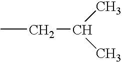 | —CH₃ | —H |
| —C₂H₅ | —C₂H₅ | —Cl | —H |
| —CH₃ | 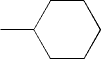 | —Cl | —H |
| —CH₃ | 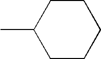 | —CH₃ | —H |
| —C₂H₅ | 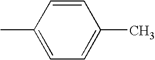 | —CH₃ | —H |
| —C₂H₅ | 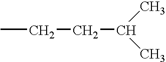 | —Cl | —H |
| —C₂H₅ | —C₂H₅ | —H | -(2-Cl) |
| —C₄H₉ | —C₄H₉ | —H | -(2-Cl) |
| —C₂H₅ | 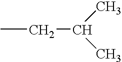 | —H | -(2-Cl) |
| —C₂H₅ | 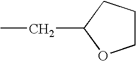 | —CH₃ | —H |

The amount of an electron-donating colorless dye-precursor in a heat-sensitive recording layer is not particularly limited, and is preferably 0.01 to 2.0 g/m^{2,} more preferably 0.1 to 0.6 g/m² in terms of the solid coating amount.

A preferable combination of the mixture of triglycerides according to the invention and the electron-donating colorless dye-precursor is a combination of at least one selected from rapeseed oil, sunflower oil, sesame oil, and peanut oil, and an electron-donating colorless dye-precursor represented by formula (A) in which R²¹ is an alkyl group having 1 to 10 carbon atoms, R²² is a methyl group, R²³ is an amido group having 2 to 8 carbon atoms, R²⁴ is an alkyl group having 1 to 5 carbon atoms, R²⁵ is an alkyl group having 1 to 5 carbon atoms, and A is a benzene ring, a benzene ring substituted by an electron-donating group, or a pyridine ring.

-Electron-Receiving Compound-

The leuco color-developing layer according to the invention may contain at least one electron-receiving compound that makes the electron-donating colorless dye-precursor develop color under heat, whereby the color-developing layer is capable of forming an image by imagewise application of heat.

The electron-receiving compound may be selected from known electron-receiving compounds, and may be a phenol derivative or a hydroxybenzoic acid ester. Inter alia, bisphenols are particularly preferable and, specifically, 2,2-bis(p-hydroxyphenyl)propane (i.e. bisphenol A), 4,4′-(p-phenylenediisopropylidene)diphenol (i.e. bisphenol P), 2,2-bis(p-hydroxyphenyl)pentane, 2,2-bis(p-hydroxyphenyl)ethane, 2,2-bis(p-hydroxyphenyl)butane, 2,2-bis(4′-hydroxy-3′,5′-dichlorophenyl)propane, 1,1-(p-hydroxyphenyl)cyclohexane, 1,1-(p-hydroxyphenyl)propane, 1,1-(p-hydroxyphenyl)pentane, 1,1-(p-hydroxyphenyl)-2-ethylhexane, butyl p-hydroxybenzoate, benzyl p-hydroxybenzoate, 2-ethylhexyl p-hydroxybenzoate, p-phenylphenol, p-cumylphenol, and 4-hydroxybenzenesulfonanilide are particularly preferable.

The amount of the electron-receiving compound in the heat-sensitive recording layer is not particularly limited, and is preferably 0.5 to 10.0 g/m², more preferably 1.0 to 5.0 g/m² in terms of the solid coating amount.

-Binder-

The leuco color-developing layer according to the invention may further contain a binder as well as the mixture of triglycerides, the electron-donating colorless dye-precursor, and the electron-receiving compound.

The binder to be used in the thermal recording layer may be a known water-soluble polymer compound or a latex. Examples of the water-soluble polymer compound include methyl cellulose, carboxymethyl cellulose, hydroxyethyl cellulose, hydroxypropyl cellulose, a starch derivative, casein, gum Arabic, an ethylene-maleic anhydride copolymer, styrene-maleic anhydride copolymer, polyvinyl alcohol, epichlorohydrin-modified polyamide, an isobutylene-maleic salicylic anhydride copolymer, polyacrylic acid, polyacrylamide, and modified products thereof. Examples of the latex include styrene-butadiene rubber latex, methyl acrylate-butadiene rubber latex, and a vinyl acetate emulsion.

-Antioxidant-

It is preferable to employ a known antioxidant in order to improve the fastness of the color image against light and heat, or in order to suppress yellow coloration in an unprinted part (non-image area) after fixation. The antioxidant maybe selected from the antioxidants described in the following patent documents: EP-A Nos. 223739, 309401, 309402, 310551, 310552 and 459416, German Patent Application Laid-Open (GP-A) No.3435443, JP-A Nos. 54-48535, 62-262047, 63-113536, 63-163351, 2-262654, 2-71262, 3-121449, 5-61166, and 5-119449, and U.S. Pat. Nos. 4,814,262 and 4,980,275, the disclosures of which are incorporated herein by reference.

In the coating liquid for the heat-sensitive recording layer of the invention, the form of the electron-donating colorless dye-precursor, the electron-receiving compound, and the after-mentioned diazonium salt compound, coupler, and basic substance is not particularly limited, and may be suitable selected according to the purpose. For example, each component may be in the form of (1) a solid dispersion, (2) an emulsion, (3) a polymer dispersion, (4) a latex dispersion, or (5) being contained in microcapsules.

Among them, it is preferable to add microcapsules containing such components to the coating liquid for the heat-sensitive recording layer from the viewpoint of the storability. In a preferable embodiment, the heat-sensitive recording layer contains microcapsules containing the electron-donating colorless dye-precursor. When the heat-sensitive recording medium comprises a heat-sensitive recording layer containing a diazonium compound and a coupler as described later, the diazonium compound is preferably contained in the microcapsules.

The electron-donating colorless dye-precursor may be encapsulated by a known method. In an exemplary embodiment, the electron-donating colorless dye-precursor and the precursor of the microcapsule wall are dissolved in an organic solvent which is insoluble or scarcely soluble in water, and then the resultant solution is added to an aqueous solution of a water-soluble polymer, and then the mixture is emulsified by a homogenizer or the like to form an emulsion, and the temperature of the emulsion is elevated to form a polymer wall at the oil/water interface, so that microcapsules containing the electron-donating colorless dye-precursor are obtained.

The wall membrane of the microcapsules may be a membrane of, for example, polyurethane resin, polyurea resin, polyamide resin, polyester resin, polycarbonate resin, aminoaldehyde resin, melamine resin, polystyrene resin, styrene-acrylate copolymer resin, styrene-methacrylate copolymer resin, gelatin, or polyvinyl alcohol. The wall membrane of the microcapsules is preferably a membrane of polyurethane-polyurea resin.

In an embodiment, microcapsules having wall membranes formed of polyurethane-polyurea resin are produced by: mixing a microcapsule wall precursor such as a polyvalent isocyanate with a core material to be encapsulated, dispersing and/or emulsifying the mixture in an aqueous solution of a water-soluble polymer such as polyvinyl alcohol, and elevating the liquid temperature to induce a polymer forming reaction at the interface on oil droplets.

Examples of the polyvalent isocyanate include a diisocyanate such-as m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-diphenylmethane-4,4′-diisocyanate, xylylene-1,4-diisocyanate, 4,4′-diphenylpropane diisocyanate, trimethylene diisocyanate, hexamethylene diisocyanate, propylene-1,2-diisocyanate, butylene-1,2-diisocyanate, cyclohexylene-1,2-diisocyanate or cyclohexylene-1,4-diisocyanate; a triisocyanate such as 4,4′,4″-triphenylmethane triisocyanate or toluene-2,4,6-triisocyanate; a tetraisocyanate such as 4,4′-dimethyldiphenylmethane-2,2′,5,5′-tetraisocyanate; and an isocyanate prepolymer such as an addition product of hexamethylene diisocyanate and trimethylolpropane, an addition product of 2,4-tolylene diisocyanate and trimethylolpropane, an addition product of xylylene diisocianate and trimethylolpropane or an addition product of tolylenediisocyanate and hexanetriol. Only one polyvalent isocyanate compound may be used, or two or more polyvalent isocyanate compounds may be used. Among these, a compound having three or more isocyanate groups is preferable.

In a preferable embodiment, the capsule wall of the microcapsule contains at least two selected from the following compound (1), compound (2), and compound (3). By using these compounds, it is easy to adequately control the particle diameter of the microcapsule. In particular, when a plurality of heat-sensitive recording layers are laminated to form a multilayer structure, addition of such compounds is effective in adjusting the heat sensitivities of the respective layers within such sensitivity regions as not to cause color mixing, and, at the same time, preventing the energy applied to the layer to be heated to the highest temperature from excessively large.

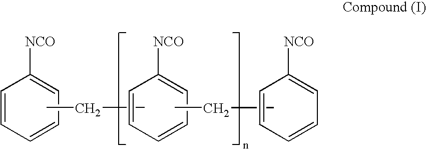

In the compound (1), n represents an integer of 0 to 2.

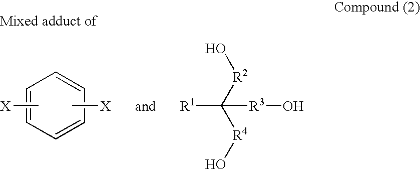

In the compound (2), X represents —CH₂—NCO or —NCO, and two Xs may be the same as or different from each other. R¹ represents a hydrogen atom or an alkyl group having 1 to 3 carbon atoms. R², R³, and R⁴ each independently represent an alkylene group having 1 to 3 carbon atoms.

Examples of the alkyl group having 1 to 3 carbon atoms represented by R¹ nclude a methyl group, an ethyl group, a propyl group, an isopropyl group, and a cyclopropyl group. Inter alia, a methyl group and an ethyl group are preferable.

Examples of the alkylene group having 1 to 3 carbon atoms represented by R², R³ or R⁴ include a methylene group, an ethylene group, a propylene group, and a trimethylene group. Inter alia, a methylene group is preferable.

In a preferable example of the compound (2), X is —CH₂—NCO, R¹ is a methyl group or an ethyl group, R² is a methylene group, R³ is a methylene group, and R⁴ is a methylene group.

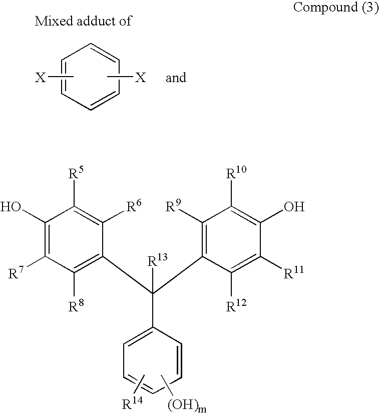

In the compound (3), X represents —CH₂—NCO or —NCO, and two Xs may be the same as or different from each other. R⁵, R⁶, R⁷, R⁸, R⁹, R¹⁰, R¹¹, and R¹² each independently represent a hydrogen atom, a halogen atom, an alkyl group, an alkoxy group, an aryl group, or an aryloxy group. R¹³ represents a hydrogen atom, an alkyl group, or an aryl group. R¹⁴ represents a hydrogen atom, an alkyl group, or an alkoxy group. Further, m represents an integer of 1 or 2.

Examples of the halogen atom represented by any of R⁵ to R¹² include a fluorine atom or a chlorine atom.

As the alkyl group represented by any of R⁵ to R¹² and R¹³ to R¹⁴, an alkyl group having 1 to 12 carbon atoms is preferable, and examples thereof include a methyl group, an ethyl group, a n-propyl group, an isopropyl group, a n-butyl group, a t-butyl group, a cyclohexyl group, a t-octyl group, a 2-ethylhexyl group, an isononyl group, and a n-decyl group. Inter alia, a methyl group, an ethyl group, a n-propyl group, a cyclohexyl group, a t-octyl group, a 2-ethylhexyl group, an isononyl group, and a n-decyl group are preferable.

The alkoxy group represented by any of R⁵ to R¹² and R¹⁴ is preferably an alkoxy group having 1 to 20 carbon atoms whose definition and preferable range are the same as those of the alkoxy group having 1 to 20 carbon atoms represented by R²³ in formula (A).

The aryl group represented by any of R⁵ to R¹² and R¹³ may have the same definition and preferable range as those of the aryl group having 6 to 10 carbon atoms represented by R²³ in formula (A).

As the aryloxy group represented by any of R⁵ to R¹², an aryloxy group having 6 to 20 carbon atoms is preferable. Examples thereof include a phenoxy group, a naphthyloxy group, a 2-methylphenyloxy group, a 4-methylphenyloxy group, a p-methoxyphenyloxy group, a p-(2-ethylhexyloxy)phenyloxy group, a 2,5-dimethylphenyloxy group, a 2,6-dimethoxyphenyloxy group, and a 2,4-di-t-amylphenyloxy group. From the viewpoint of solubility, a 2-methylphenyloxy group, a 4-methylphenyloxy group, a p-(2-ethylhexyloxy)phenyloxy group, and a 2,4-di-t-amylphenyloxy group are preferable.

In a preferable example of the compound (3), X is —CH₂NCO; R⁵, R⁷, R¹⁰ and R¹¹ are each a hydrogen atom, a methyl group or a cyclohexyl group; at least one of R⁵ and R⁷ is different from a cyclohexyl group; at least one of R¹⁰ and R¹¹ is different from a cyclohexyl group; R⁶, R⁸, R⁹ and R¹² are each a hydrogen atom or a methyl group; R¹³ is a hydrogen atom or a methyl group; R¹⁴ is a hydrogen atom or a methyl group; and m is 2.

Among the foregoing, preferable examples that can be used together with at least two selected from the compound (1), compound (2) and compound (3) include an adduct of m-phenylene diisocyanate and trimethylolpropane, an adduct of p-phenylene diisocyanate and trimethylolpropane, an adduct of m-phenylene diisocyanate and bis(2-methyl-5-cyclohexyl-4-hydroxyphenyl)-3,4-dihydroxyphenylmethane, an adduct of m-xylylene diisocyanate, trimethylolpropane, and polyethylene glycol, an adduct of p-xylylene diisocyanate and isopropylidenediphenol, an adduct of m-xylylene diisocyanate and 2-methyl-2,4-dihydroxypentane, and an adduct of m-xylylene diisocyanate and 1,1,3-tris(2-methyl-4-hydroxy-5-cyclohexylphenyl)butane.

In the method of encapsulating the electron-donating colorless dye-precursor, the solvent to be used for dissolving the electron-donating colorless dye-precursor comprises the above-mentioned mixture of fatty acid triglycerides (vegetable oil). Other organic solvents may be used additionally, and examples thereof include low-boiling auxiliary solvents such as acetate esters, methylene chloride, and cyclohexane, phosphoric acid esters, phthalic acid esters, acrylic acid esters, methacrylic acid esters, other carboxylic acid esters, fatty acid amides, alkylated biphenyls, alkylated terphenyls, alkylated naphthalenes, diarylethanes, chlorinated paraffin, alcoholic solvents, phenolic solvents, ether solvents, monoolefin solvents, and epoxy solvents. Specific examples thereof include high-boiling oils such as tricresyl phosphate, trioctyl phosphate, octyldiphenyl phosphate, tricyclohexyl phosphate, dibutyl phthalate, dioctyl phthalate, dilauryl phthalate, dicyclohexyl phthalate, butyl olefinate, diethylene glycol benzoate, dioctyl sebacate, dibutyl sebacate, dioctyl agipate, trioctyl trimellitate, acetyltriethyl citrate, octyl maleate, dibutyl maleate, isoamylbiphenyl, chlorinated paraffin, diisopropylnaphthalene, 1,1′-ditolylethane, 2,4-ditertiary-amylphenol, N,N-dibutyl-2-butoxy-5-tertiary-octylaniline, hydroxybenzoic acid 2-ethylhexyl ester, and polyethylene glycol. Only one additional solvent may be used, or two or more additional solvents may be used. Among these, alcohol solvents, phosphoric acid esters, carboxylic acid esters, alkylated biphenyls, alkylated terphenyls, alkylated naphthalenes, and diarylethanes are preferable.

Examples of the water-soluble polymer contained in the aqueous phase in which the oil phase of the microcapsules is to be dispersed (emulsified) include polyvinyl alcohol, silanol-modified polyvinyl alcohol, carboxy-modified polyvinyl alcohol, amino-modified polyvinyl alcohol, itaconic acid-modified polyvinyl alcohol, a styrene-maleic anhydride copolymer, a butadiene-maleic anhydride copolymer, an ethylene-maleic anhydride copolymer, an isobutylene-maleic anhydride copolymer, polyacrylamide, polyethylenesulfonic acid, polyvinylpyrrolidone, an ethylene-acrylic acid copolymer, and gelatin.

The method of encapsulating the diazonium compound or the like is similar to that employed for encapsulating the electron-donating colorless dye-precursor.

In the invention, the average particle diameter of the microcapsules is preferably 0.7 to 2.0 μm. Such a small particle diameter of the microcapsules is effective in storage stability, and enhances the improvement of raw storability caused by the use of the mixture of triglycerides, as described above.

Inter alia, the average particle diameter of the microcapsules is more preferably 0.70 to 1.5 μm.

The average particle diameter of the microcapsules is the volume-based median diameter. Specifically, the diameter is a value measured with a laser diffraction/scattering-type particle size distribution measuring apparatus (trade name; LA700, manufactured by HORIBA). Prior to measurement, a microcapsule solution having a temperature of 40° C. is prepared such that the transmittance of the light for measurement is 69 to 74%, and then the microcapsule solution is stirred and irradiated with ultrasound for 2 minutes in this state, and then the measurement is conducted.

In the invention, the heat-sensitive recording material may have multiple layers including the lamination of a plurality of heat-sensitive recording layers. When the heat-sensitive recording material has a plurality of heat-sensitive recording layers, color developing agents that require different amounts of energy for color development are used. The heat-sensitive recording material of the invention may be full-color or monochromatic. In a preferable embodiment, the heat-sensitive recording layer has, in addition to the leuco color-developing layer according to the invention, at least one diazo color-developing layer (photofixable heat-sensitive recording layer) containing, as main components, a diazo compound, a diazo-based color developing agent containing a coupler that undergoes coupling reaction with the diazo compound, and a binder.

The diazo color-developing layer may further contain a basic substance that promotes the color developing reaction of the diazonium salt compound and the coupler.

In addition, the color developing agent of heat-sensitive recording layers other than the leuco color-developing layer according to the invention, may be a diazo-based color developing agent such as described above, a base color-developing system that develops color upon contact with a basic compound, a chelate color-developing system, or a color-developing system that develops color by an elimination reaction occurring upon reaction with a nucleophile.

Details of the diazonium salt compound and of the coupler that reacts with the diazonium salt compound under heat to develop color are described in JP-A No. 2003-276339 and JP-A No.2004-322356, and can be appropriately selected. Diazonium salt compounds and couplers preferred in the invention will be described below.
<Diazonium Salt Compound having Maximum Absorption Wavelength in the Range of 445±50 nm>

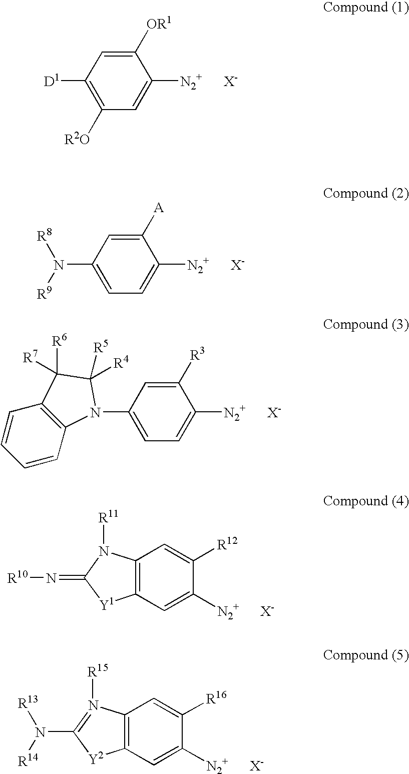

In formulas (1) to (5), R², R², R⁴ to R¹¹, and R¹³ to R¹⁵ may be the same as or different from each other, and each independently represent a hydrogen atom, an alkyl group, or an aryl group; R³, R¹², and R¹⁶ represent a hydrogen atom, an alkyl group, an alkoxy group, a halogen atom, a sulfonyl group, an acyl group, or an alkoxycarbonyl group; D¹ represents an electron-donating group having a Hammett σₚ value of −0.05 or less which is preferably a substituted amino group, an alkylthio group, an arylthio group, an alkoxy group or an aryloxy group; X⁻represents a counter-anion; A represents an electron-withdrawing group having a Hammett σₚ value of 0.3 or more; and Y¹ and Y² each represent an oxygen atom or a sulfur atom. Each benzene ring in formulas (1) to (5) may further have a substituent.

R¹, R², R⁴ to R¹¹, and R¹³ to R¹⁵ are each preferably a hydrogen atom, an alkyl group having 1 to 15 carbon atoms, or an aryl group having 6 to 10 carbon atoms, more preferably a hydrogen atom, an alkyl group having 1 to 10 carbon atoms, or a phenyl group. The alkyl group may be branched, and may be substituted by a halogen atom, an alkoxy group, an aryloxy group, a phenyl group, an alkoxycarbonyl group, an acyloxy group, or a carbamoyl group. In addition, the phenyl group may be substituted by a halogen atom, an alkyl group, an aryl group, an acyloxy group, an alkoxy group, an aryloxy group, an alkoxycarbonyl group, or an acyl group.

Examples of R¹, R², R⁴ to R¹¹, and R¹³ to R¹⁵ are shown below.

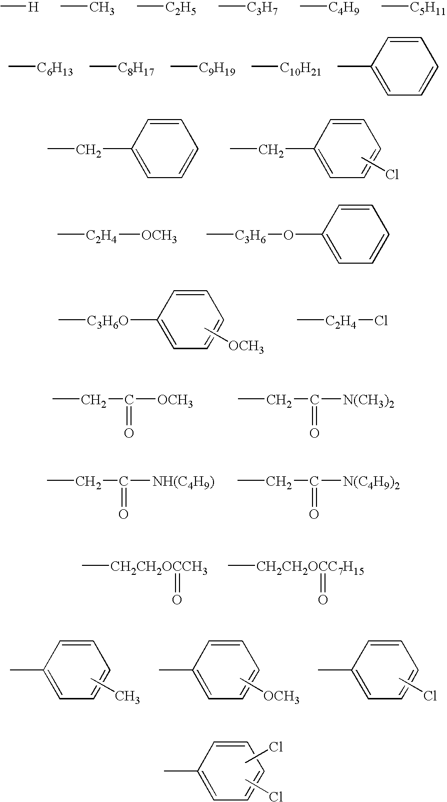

R³, R², and R¹⁶ are preferably a hydrogen atom, an alkyl group having 1 to 8 carbon atoms, a chlorine atom, a fluorine atom, an alkoxy group having 1 to 15 carbon atoms, an alkylsulfonyl group having 1 to 12 carbon atoms, an arylsulfonyl group having 6 to 18 carbon atoms, an acyl group having 1 to 18 carbon atoms, or an alkoxycarbonyl group having 2 to 18 carbon atoms. The alkyl group and the alkylsulfonyl group may be branched, and may be substituted by a halogen atom, an alkoxy group, an aryloxy group, a phenyl group, an alkoxycarbonyl group, an acyloxy group, or a carbamoyl group.

The arylsulfonyl group may be substituted by a halogen atom, an alkyl group, or an alkoxy group.

Examples of R³, R¹², and R¹⁶ are shown below.

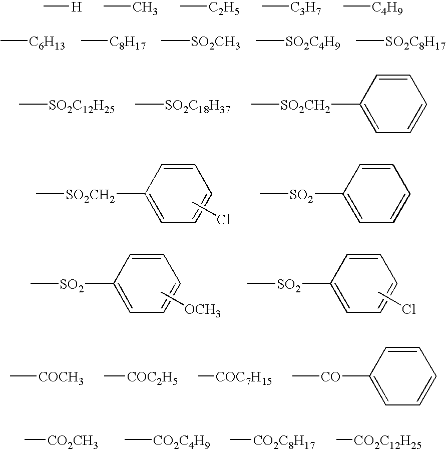

Further, A is preferably a sulfonyl group, an acyl group, an alkoxycarbonyl group, or a cyano group. The sulfonyl, acyl, or alkoxycarbonyl group has the same definition and preferable range as those of the sulfonyl, acyl, or alkoxycarbonyl group represented by R³.

R⁸ and R⁹ may be bonded to each other to form a ring. R¹³ and R¹⁴ may be bonded to each other to form a ring.

Examples of counter-anion X- include a perfluoroalkylcarboxylic acid having 1 to 20 carbon atoms (e.g. perfluorooctanoic acid, perfluorodecanoic acid, perfluorododecanoic acid), a perfluoroalkylsulfonic acid having 1 to 20 carbon atoms (e.g. perfluorooctanesulfonic acid, perfluorodecanesulfonic acid, perfluorohexadecanesulfonic acid), an aromatic carboxylic acid having 7 to 50 carbon atoms (e.g. 4,4-di-t-butylsalicylic acid, 4-t-octyloxybenzoic acid, 2-n-octyloxybenzoic acid, 4-t-hexadecylbenzoic acid, 2,4-bis-n-octadecyloxybenzoic acid, 4-n-decylnaphthoic acid), an aromatic sulfonic acid having 6 to 50 carbon atoms (e.g. 1,5-naphthalenedisulfonic acid, 4-t-octyloxybenzenesulfonic acid, 4-n-dodecylbenzenesulfonic acid), 4,5-di-t-butyl-2-naphthoic acid, tetrafluoroboric acid, tetraphenylboric acid, hexafluorophosphoric acid, a bis(alkylsulfonyl)imine having 2 to 20 carbon atoms, and a bis(perfluoromethanesulfonyl)imine having 2 to 20 carbon atoms. Inter alia, a perfluoroalkylcarboxylic acid having 6 to 16 carbon atoms, an aromatic carboxylic acid having 10 to 40 carbon atoms, an aromatic sulfonic acid having 10 to 40 carbon atoms, tetrafluoroboric acid, tetraphenylboric acid, hexafluorophosphoric acid, and a bis(perfluoromethanesulfonyl)imine having 2 to 20 carbon atoms are preferable.

When D¹ represents a substituted amino group as an electron-donating group having a Hamnmett σₚ of −0.05 or less, the amino acid group is preferably an alkylamino group having 1 to 20 carbon atoms, a dialkylamino group having 2 to 20 carbon atoms, an arylamino group having 6 to 10 carbon atoms, a N-alkyl-N-arylamino group having 7 to 20 carbon atoms, or an acylamino group having 2 to 20 carbon atoms. These groups may have one or two or more additional substituents. Substituents such as alkyl groups may be bonded to each other to form a cyclic amino group.

When D¹ represents an alkylthio group as an electron-donating group having a Hammett σₚ of −0.05 or less, the alkylthio group preferably has 1 to 18 carbon atoms. When D¹ represents an arylthio group, the arylthio group preferably has 6 to 10 carbon atoms. When D¹ represents an alkoxy group, the alkoxy group preferably has 1 to 18 carbon atoms. When D¹ represents an aryloxy group, the aryloxy group preferably has 6 to 10 carbon atoms. These groups each may have one or two or more additional substituents.

From the viewpoint of stability of the diazonium salt compound, D¹ is preferably a dialkylamino group, a N-alkyl-N-arylamino group, an acylamino group, an alkylthio group, an arylthio group, an alkoxy group, or an aryloxy group.

Examples of the alkyl and aryl groups in substituted amino groups, alkylthio groups, arylthio groups, alkoxy groups, and aryloxy groups as examples of the electron-donating group having a Hammett σₚ value of −0.05 or less represented by D¹ are shown below.

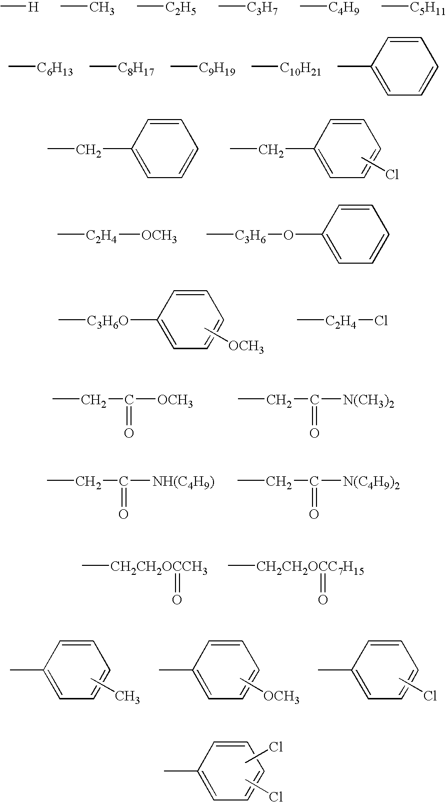

When D¹ in formula (1) represents a substituted amino group, the substituents thereon may be bonded to each other to form a cyclic amino group. Further, —N(R⁸)R⁹ in formula (2) and —N(R¹³)R¹⁴ in formula (B) each may be a cyclic group. Exarnples of the cyclic amino group and cyclic group are shown below.

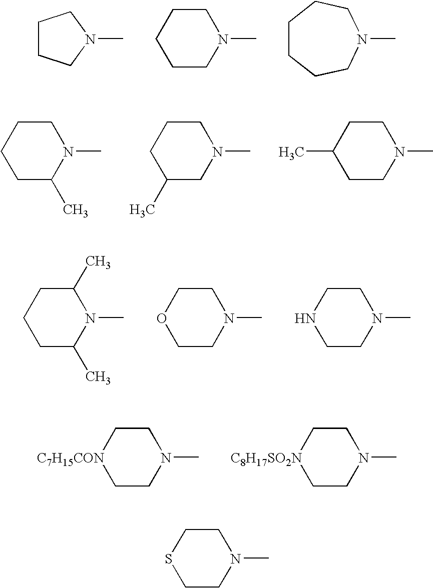

The benzene ring on the indolyl group of formula (3) may have a nuclear substituent. The nuclear substituent is preferably an electron-withdrawing group from a viewpoint of the stability of the ring. The Hammett σₚ value of the electron withdrawing group is preferably 0.1 or more. Inter alia, an acyl group, a sulfonyl group, an alkoxycarbonyl group, a sulfonamido group, or a carbonamido group is preferable. The acyl group, the sulfonyl group, and the alkoxycarbonyl group have the same defintions and preferable ranges as in the above description of R³. The sulfonamido group preferably has 1 to 12 carbon atoms. Examples thereof are shown below.

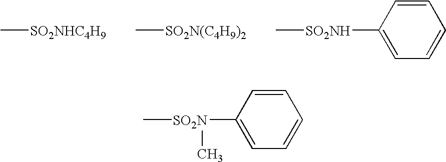

The carbonamido group preferably has 2 to 13 carbon atoms, and examples thereof are shown below.

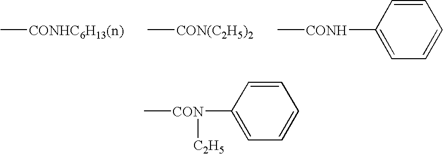

Examples (exemplified compounds (DA-1) to (DA-16)) of the diazonium salt compound (DA compound) represented by formulas (1) to (5) are shown below, but the invention is not limited thereto. 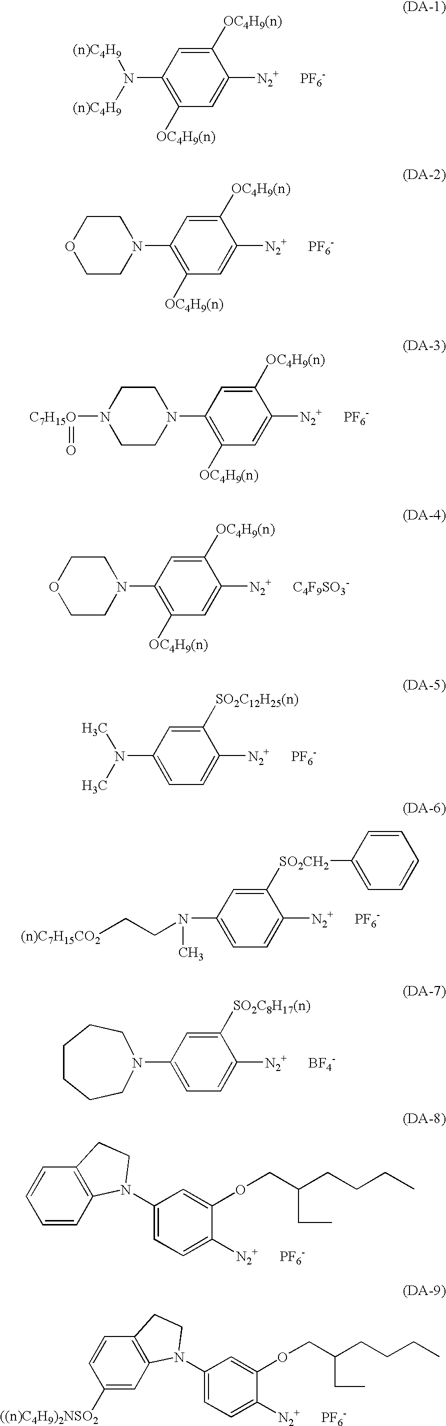 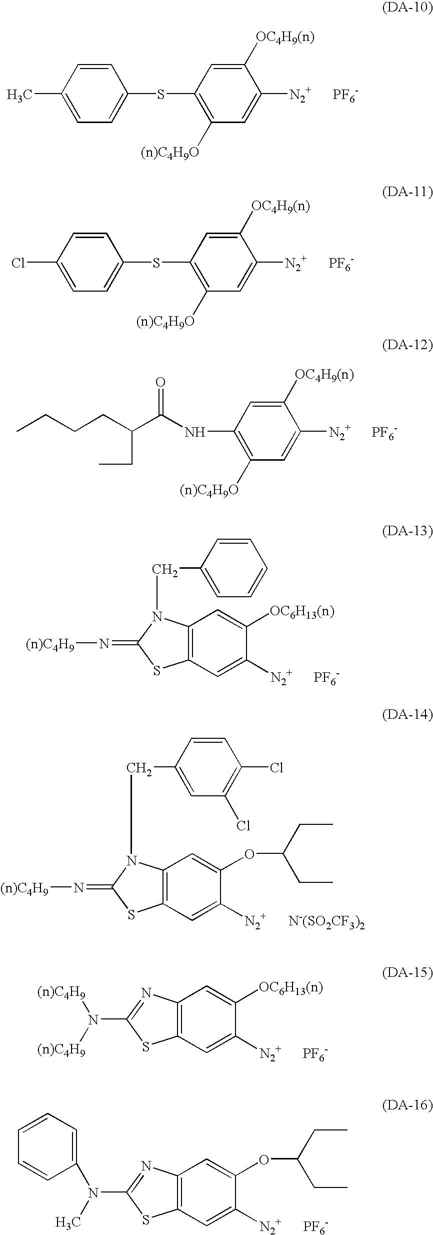
<Diazonium Salt Compound having the Maximum Absorption Wavelength in the Range of 365±30 nm>

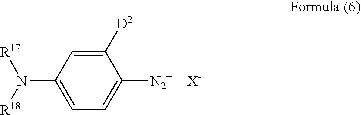

In formula (6), R¹⁷ or R¹⁸ has the same definition and preferable range as those of R¹ in formula (1).

D² represents an alkoxy group or an aryloxy group. The alkyl portion of the alkoxy group and the aryl portion of the aryloxy group have the same defmitions and preferable ranges as those of the alkyl group and the aryl group represented by R¹ in formula (1), respectively.

Examples (exemplified compounds (DB-1) to (DB-6)) of the diazonium salt compound represented by formula (6) are shown below. However, the invention is not limited thereto. 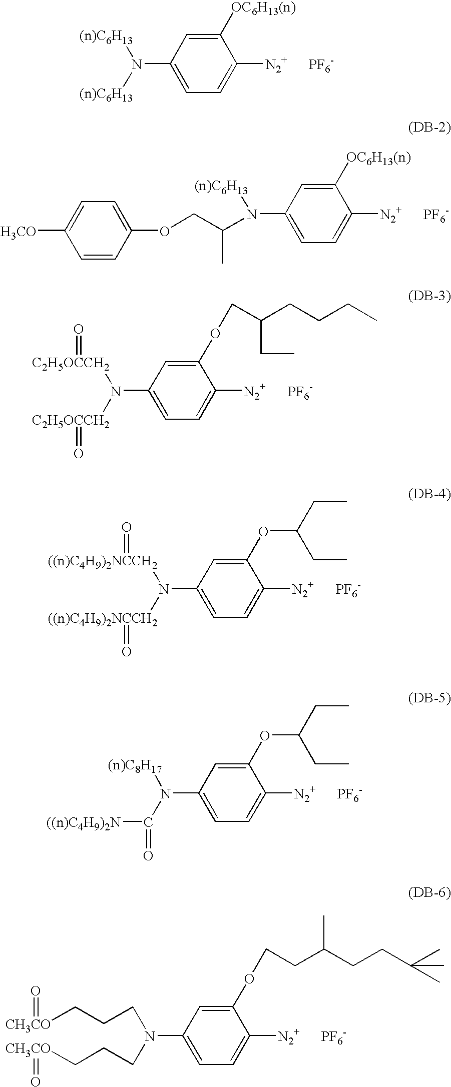
<Diazonium Salt Compound having the Maximum Absorption Wavelength in the Range of 305±30 nm>

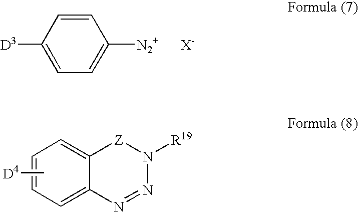

In formulas (7) and (8), D³ and D⁴ each represent a group having a Hammett σₚ value of −0.45 or more. R¹⁹ represents a perfluoroalkyl group, an acyl group, or a sulfonyl group. The acyl group and the sulfonyl group have the same definitions as in the above description of R³. The perfluoroalkyl group preferably has 1 to 8 carbon atoms, and is particularly preferably —CF₃, —C₃F₇ or —C₈F₁₇.

X⁻in formula (7) represents a counter-anion. Z in formula (8) represents —SO₂— or —CO—.

The group having a Hammett σₚ value of −0.45 or more represented by D³ or D⁴ is preferably an alkoxy group, an aryloxy group, an alkyl group, an alkylthio group, an arylthio group, a halogen atom, a hydrogen atom, a nitro group, a cyano group, an alkylsulfonyl group, or an alkoxycarbonyl group. The group more preferably has a Hammett σₚ value of −0.30 or more.

The alkoxy group is preferably an optionally-substituted alkoxy group having 1 to 20 carbon atoms, and examples thereof include methoxy (σₚ=−0.27), ethoxy, butyloxy (σₚ=−0.32), hexyloxy, octyloxy, 2-ethylhexyloxy, 3-methyl-5,5-dimethylhexyloxy, decyloxy, phenoxyethoxy, and 2-(2,4-di-t-pentylphenyl)oxyethyloxy.

The aryloxy group is preferably an optionally-substituted aryloxy group having 6 to 20 carbon atoms, and examples thereof include phenoxy (σₚ=−0.03), methylphenoxy, isopropylphenoxy, 2,4-di-t-pentylphenoxy, chlorophenoxy, and methoxyphenoxy.

The alkyl group is preferably an alkyl group having 1 to 8 carbon atoms, and examples thereof include methyl (σₚ=−0.17), ethyl, isopropyl, t-butyl, hexyl, and octyl.

The alkylthio group is preferably an optionally-substituted alkylthio group having 1 to 8 carbon atoms, and examples thereof include methylthio, ethylthio (σₚ=0.03), butylthio, octylthio, and benzylthio.

The arylthio group is preferably an optionally-substituted arylthio group having 6 to 10 carbon atoms, and examples thereof include phenylthio (σₚ=0. 18), methylphenylthio, chlorophenylthio, and methoxyphenylthio.

The halogen atom is preferably a chlorine atom (σₚ=0.23) or a fluorine atom (σₚ=0.06).

The alkylsulfonyl group is preferably an,alkylsulfonyl group having 1 to 8 carbon atoms, and examples thereof include methylsulfonyl (σₚ=0.72), ethylsulfonyl, butylsulfonyl, octylsulfonyl, and benzylsulfonyl.

The alkoxycarbonyl group is preferably an alkoxycarbonyl group having 2 to 10 carbon atoms, and examples thereof include methoxycarbonyl, ethoxycarbonyl (σₚ=0.45), butyloxycarbonyl, and octyloxycarbonyl.

X⁻in formula (7) has the same definition as in formula (1).

The benzene ring in formula (7) or (8) may further have a substituent.

The substituent may be any substituent, and is preferably selected from an alkyl group, an alkoxy group, an aryloxy group, an alkylthio group, an arylthio group, a halogen atom, a nitro group, a cyano group, an alkylsulfonyl group, and an alkoxycarbonyl group. The alkyl group, the alkoxy group, the alkylthio group, the arylthio group, the halogen atom, the alkylsulfonyl group, and the alkoxycarbonyl group have the same definitions as in the above description of D³.

In formula (7), it is preferable that the benzene ring is substituted at the ortho position (o-position) relative to the diazonio group.

Examples (exemplified compounds (DC-1) to (DC-6)) of dizonium salt compounds represented by formulas (7) and (8) are shown below, but the invention is not limited thereto.

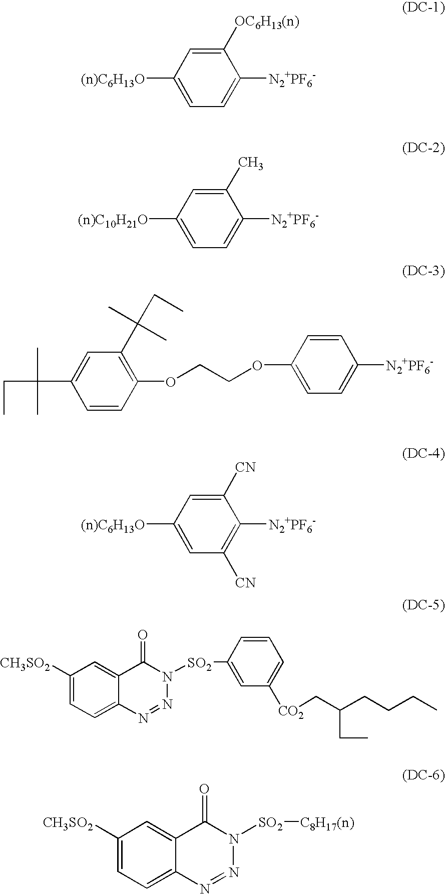

In addition, the diazonium salt compound may be oily or crystalline, and is preferably in the crystalline state at a normal temperature from the viewpoint of handling. Only one of such diazonium salt compounds may be used, or two or more of such diazonium compounds may be used. Any of the diazonium compound described above may be used in combination with one or more known diazonium salt compounds.

The content of the diazonium salt compound in the diazo color-developing layer is preferably 0.02 to 5 g/m², more preferably 0.1 to 4 g/m² from the viewpoint of the density of the developed color.

For stabilizing the diazonium salt compound, zinc chloride, cadmium chloride, or tin chloride may be used to form a complex compound, thereby stabilizing the diazonium salt compound.

(Coupler)

The coupler may be any compound as far as it undergoes coupling reaction with a diazonium salt compound in the basic atmosphere and/or the neutral atmosphere to form a dye. Any of so-called 4 equivalent coupler compounds for a silver halide photographic photosensitive material can be used as the coupler. In addition, some of 2-equivalent couplers are also usable. The coupler may be selected depending on the target hue.

Examples thereof include a so-called active methylene compound having a methylene group adjacent to a carbonyl group, a phenol derivative, and a naphthol derivative, and these may be used in a range suitable for the purpose.

Details of the coupler are described in JP-A No. 4-201483,JP-A No. 7-223367, JP-A No. 7-223368, JP-A No. 7-323660, JP-A No. 7-125446, JP-A No. 7-96671, JP-A No. 7-223367, JP-A No. 7-223368, JP-A No. 9-156229, JP-A No. 9-216468, JP-A No. 9-216469, JP-A No. 9-203472, JP-A No. 9-319025, JP-A No. 10-35113, JP-A No. 10-193801, and JP-A No. 10-264532.

Among the aforementioned compounds, a compound represented by the following formula (9) or a tautomer thereof is particularly preferable in the invention.

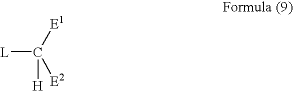

In formula (9), E¹ and E² each independently represent an electron withdrawing group, and L represents a group which can be eliminated upon azo coupling to form an azo pigment. E¹ and E² may be bonded to each other to form a ring.

The electron withdrawing groups represented by E¹ and E² are substituents each having a positive Hammett σ^{p} value, and these may be the same as or different from each other. Preferable examples include: acyl groups such as an acetyl group, a propionyl group, a pivaloyl group, a chloroacetyl group, a trichloroacetyl group, a trifluoroacetyl group, a 1-methylcyclopropylcarbonyl group, a 1-ethylcyclopropylcarbonyl group, a 1-benzylcyclopropylcarbonyl group, a benzoyl group, a 4-methoxybenzoyl group, and a thenoyl group; oxycarbonyl groups such as a methoxycarbonyl group, an ethoxycarbonyl group, a 2-methoxyethoxycarbonyl group, and a 4-methoxyphenoxylcarbonyl group; carbamoyl groups such as a carbamoyl group, a N,N-dimethylcarbamoyl group, a N,N-diethylcarbamoyl group, a N-phenylcarbamoyl group, a N-[2,4-bis(pentyloxy)phenyl]carbamoyl group, a N-[2,4-bis(octyloxy)phenyl]carbamoyl group, and a morpholinylcarbonyl group; alkylsulfonyl groups and arylsulfonyl groups such as a methanesulfonyl group, a benzenesulfonyl group, and a toluenesulfonyl group; phosphono groups such as diethylphosphono group; heterocyclic groups such as a benzoxazol-2-yl group, a benzothiazol-2-yl group, a 3,4-dihydroquinazoline-4-one-2-yl group, and a 3,4-dihydroquinazoline-4-sulfone-2-yl group; a nitro group; an imino group; and a cyano group.

The electron withdrawing groups represented by E¹ and E² may be bonded to each other to form a ring. The ring formed by the combination of E¹ and E² is preferably a 5-membered or 6-membered carbocycle or heterocycle.

L in formula (9) represents a group which is eliminated upon azo coupling, and examples of the leaving group L include halogen atoms (e.g., fluorine, bromine, chlorine, and iodine), substituted alkyl groups (e.g., a hydroxymethyl group and a dimethylaminomethyl group), alkylthio groups (e.g. an ethylthio group, a 2-carboxyethylthio group, a dodecylthio group, and a 1-carboxydodecylthio group), arylthio groups (e.g. a phenylthio group and a 2-butoxy-t-octylphenylthio group), alkoxy groups (e.g. an ethoxy group, a dodecyloxy group, a methoxyethylcarbamoylmethoxy group, a carboxypropyloxy group, a methylsulfonylethoxy group, and an ethoxycarbonylmethoxy group), allyloxy groups (e.g. a 4-methylphenoxy group, a 4-chlorophenoxy group, a 4-methoxyphenoxy group, a 4-carboxyphenoxy group, a 3-ethoxycarboxyphenoxy group, a 3-acetylaminophenoxy group, and a 2-carboxyphenoxy group), acyloxy groups (e.g. an acetoxy group, a tetradecanoyloxy group, and a benzoyloxy group), arylsulfonyloxy groups (e.g. a toluenesulfonyloxy group), dialkylaminocarbonyloxy groups (e.g. a dimethylaminocarbonyloxy group and a diethylaminocarbonyloxy group), diarylaminocarbonyloxy groups (e.g. a diphenylaminocarbonyloxy group), alkoxycarbonyloxy groups (e.g. an ethoxycarbonyloxy group and a benzyloxycarbonyloxy group), aryloxycarbonyloxy groups (e.g. a phenoxycarbonyloxy group), and heterocyclic groups (e.g. an imidazolyl group, a pyrazolyl group, a triazolyl group, and a tetrazolyl group).

Examples of the coupler represented by forrnula (9) are shown below, but the invention is not limited thereto. Tautomers of the couplers shown below are also preferable.

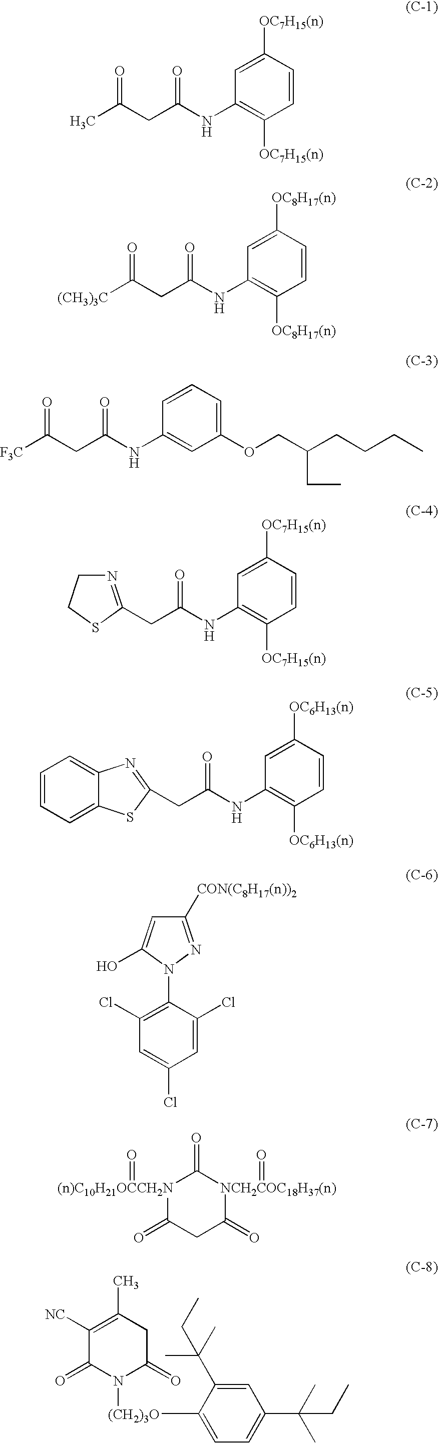

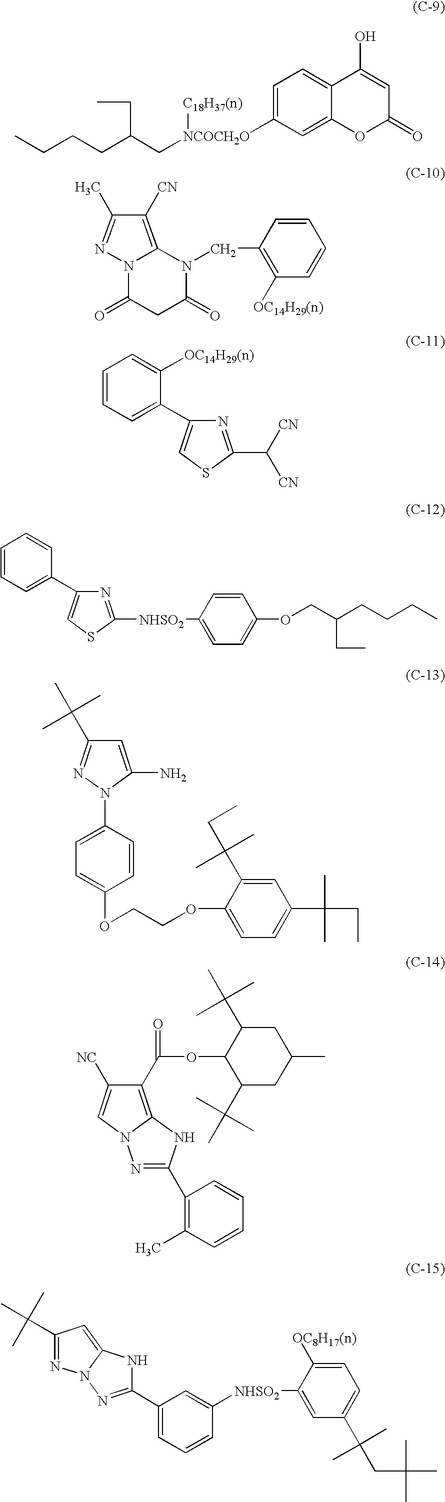

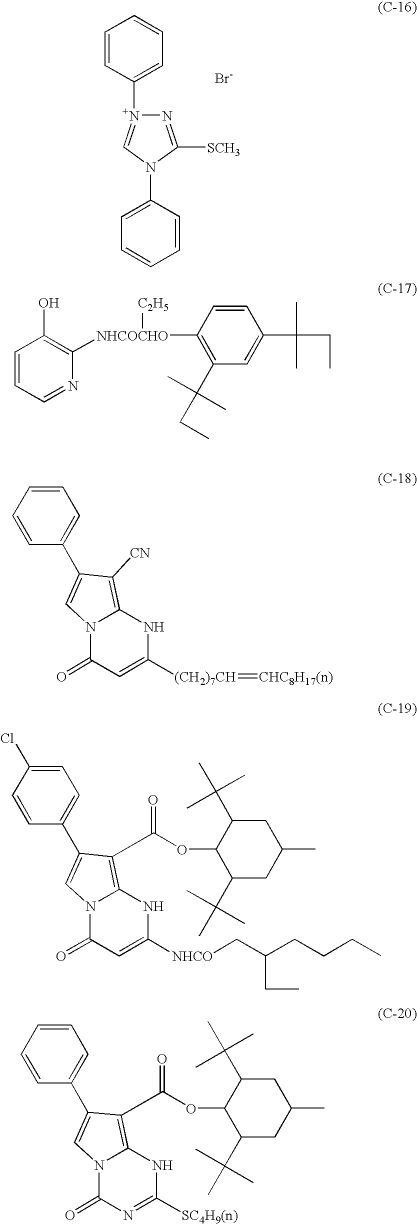

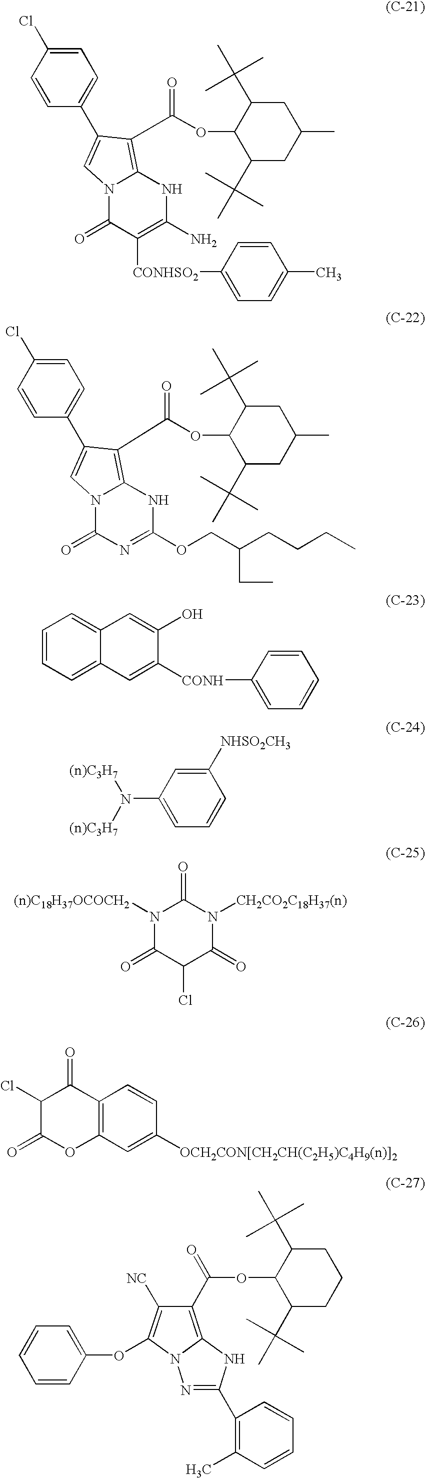

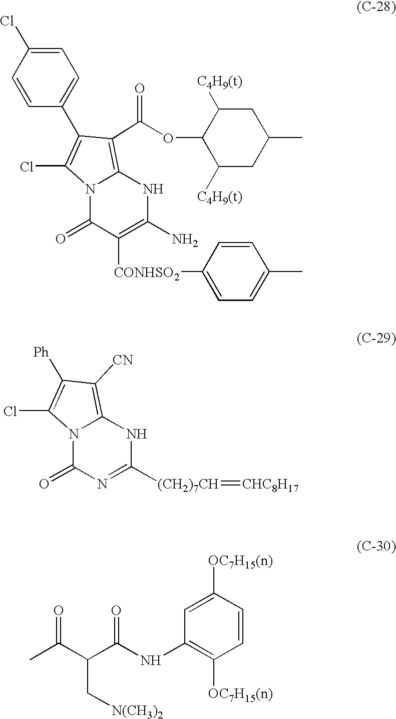

Further examples include the following compounds.

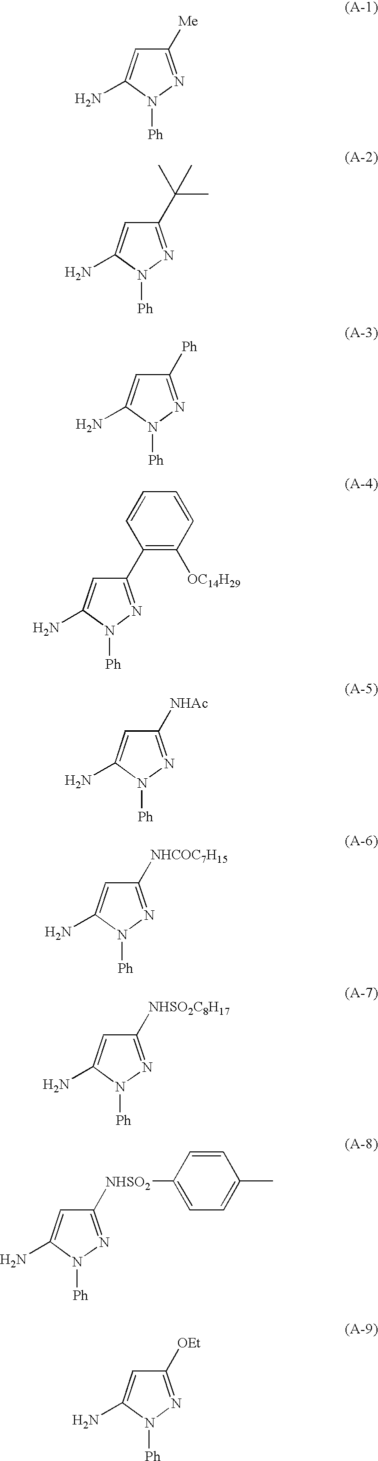

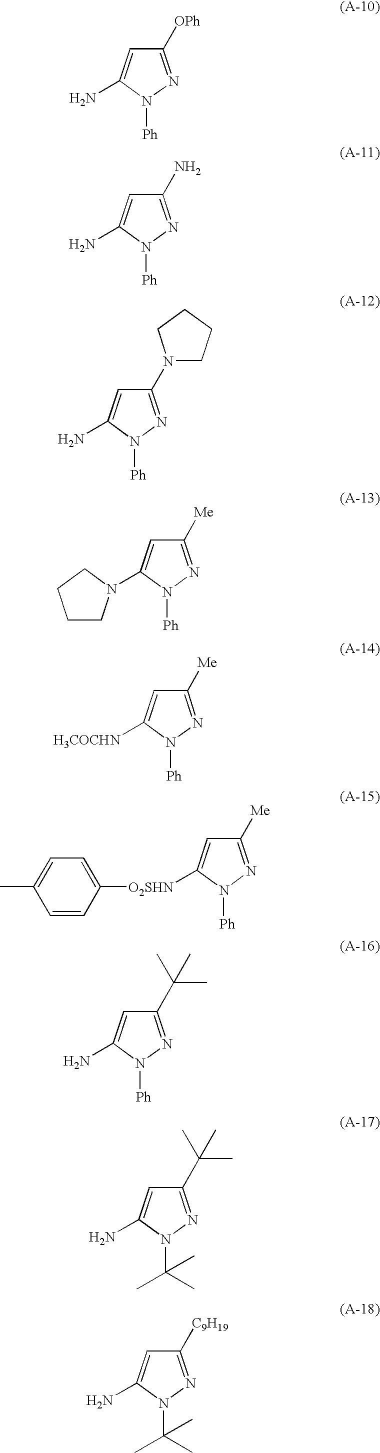

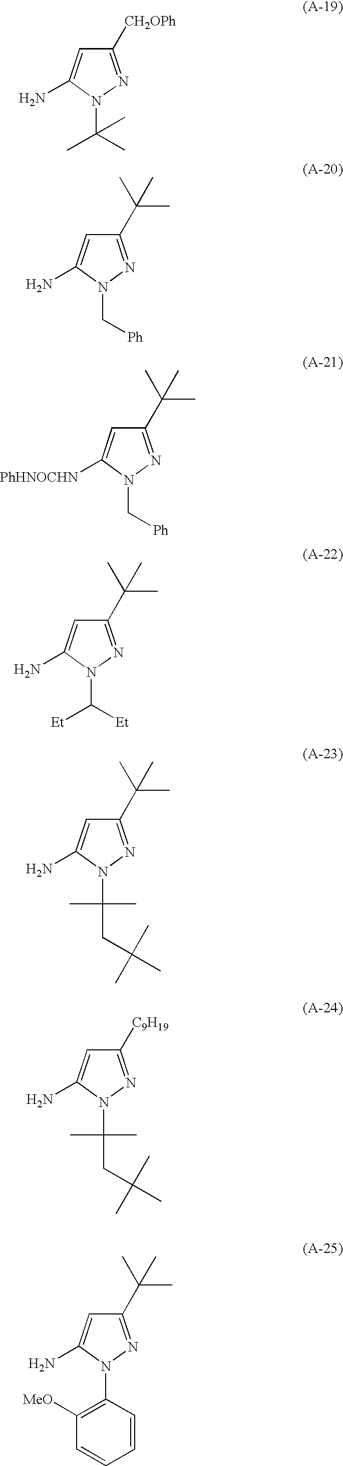

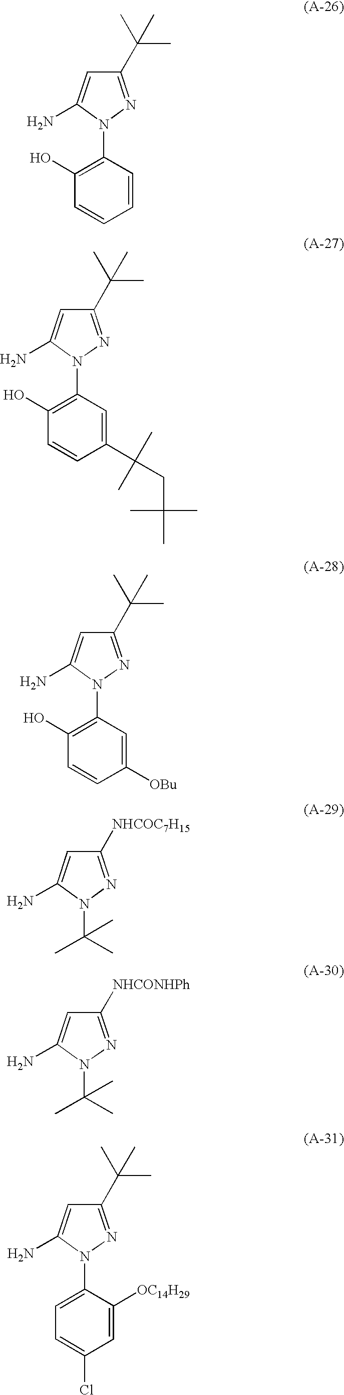

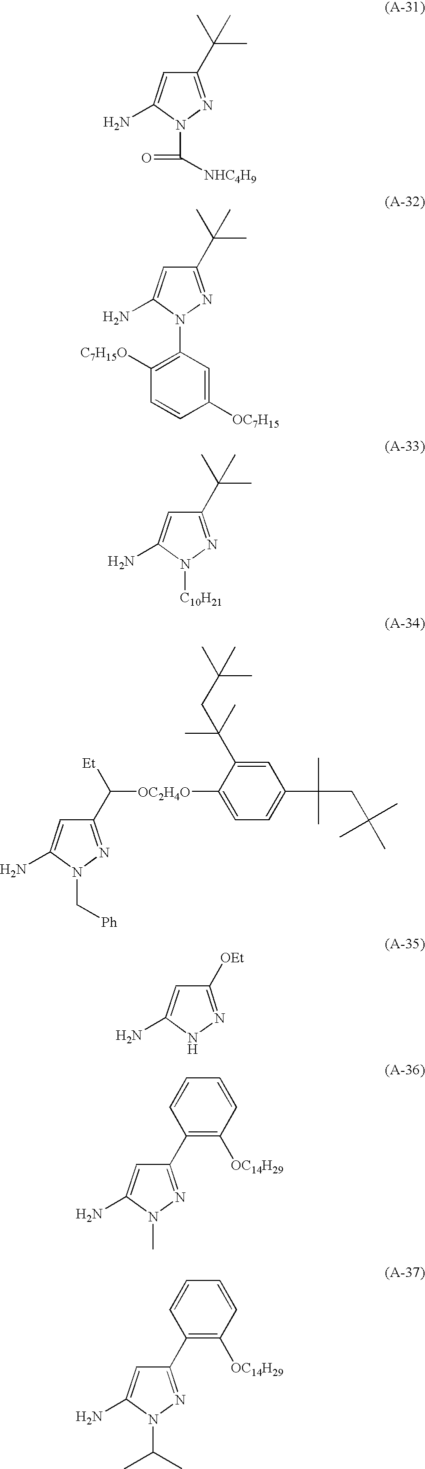

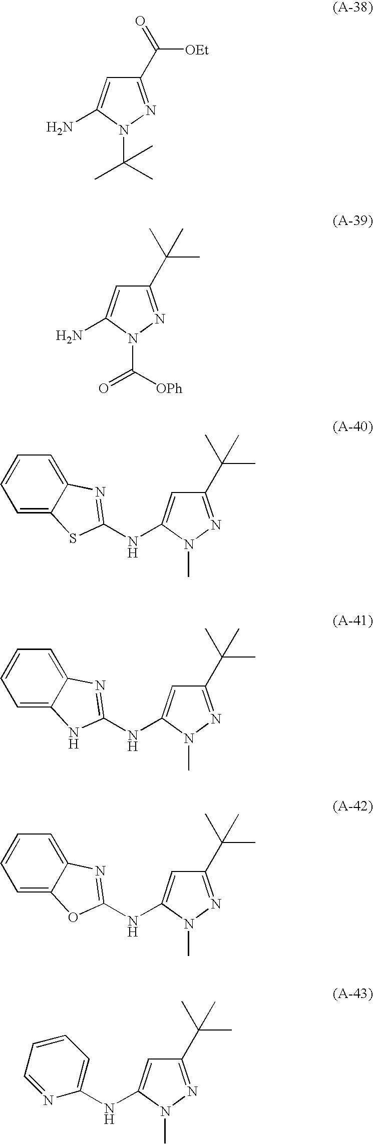

The basic substance is not particularly limited, and can be appropriately selected from known substances in accordance with the purpose. The basic substance may be an inorganic or organic basic compound, or a compound which is degraded under heat to release an alkaline substance. A typical example is a nitrogen-containing compound whose examples include organic ammonium salts, organic amines, amides, urea and thiourea and derivatives thereof, thioazoles, pyrroles, pyrimidines, piperazines, guanidines, indoles, imidazoles, imidazolines, triazoles, morpholines, piperidines, amidines, formazines, and pyridines.

Specific examples thereof include tricyclohexylamine, tribenzylamine, octadecylbenzylamnine, stearylamine, allylurea, thiourea, methylthiourea, allylthiourea, ethylenethiourea, 2-benzylimidazole, 4-phenylimidazole, 2-phenyl-4-methylimidazole, 2-undecylimidazoline, 2,4,5-trifuryl-2-imidazoline, 1,2-diphenyl-4,4-dimethyl-2-imidazoline, 2-phenyl-2-imidazoline, 1,2,3-triphenylguanidine, 1,2-dicyclohexylguanidine, 1,2,3-tricyclohexylguanidine, guanidine trichloroacetate, N,N′-dibenzylpiperazine, 4,4′-dithiomorpholine, morpholium trichloroacetate, 2-aminobenzothioazole, and 2-benzylhydrazinobenzothioazole. Only one basic compound may be used, or two or more basic compounds may be used in combination.

The heat-sensitive recording material may be a multicolor heat-sensitive recording material having a multilayer structure comprising a lamination of a plurality of heat-sensitive recording layers that develop colors in respectively different hues. The layer construction of the multicolor heat-sensitive material is not particularly limited, and may be selected appropriately in accordance with the purpose. In a preferable embodiment, the multicolor heat-sensitive recording layers include a lamination of two diazo color-developing layers and the leuco color-developing layer according to the invention; each diazo color-developing layer contains a combination of a diazonium salt compound having a photosensitive wavelength that is different from that of the diazonium salt compound in the other diazo color-developing layer and a coupler that react with the diazonium compound under heat to develop a color in a hue that is different from that developed by the other diazo color-developing layer, and the leuco color-developing layer contains a combination of an electron-donating colorless dye and an electron-receiving compound. In a preferable specific example of the multicolor heat-sensitive recording material, a leuco color-developing layer A according to the invention, a diazo color-developing layer B-1, and a diazo color-developing layer B-2 are disposed on the after-mentioned support in this order from the support. The leuco color-developing layer A contains an electron-donating colorless dye and an electron-receiving compound. The diazo color-developing layer B-1 contains a diazonium salt compound having the maximum absorption wavelength of 360±20 nm and a coupler that react with the diazonium salt compound under heat to develop color, and the diazo color-developing layer B-2 contains a diazonium salt compound having the maximum adsorption wavelength of 400±20 nm and a coupler that reacts with the diazonium salt compound under heat to develop color.

In an exemplary method of recording an image on this multicolor heat-sensitive recording material:

first, the diazo color-developing layer B-2 is heated to allow the diazonium salt compound and the coupler contained in the diazo color-developing layer B-2 to develop color;

and then the diazo color-developing layer B-2 is irradiated with light of 400±20 nm, whereby the unreacted diazonium salt compound contained in the diazo color-developing layer B-2 is degraded;

thereafter, sufficient heat for the color development of the diazo color-developing layer B-1 is applied to allow the diazonium salt compound and the coupler contained in the diazo color-developing layer B-1 to develop color (during which the diazo color-developing layer B-2 is also strongly heated, but does not cause further color development since the diazonium salt compound has been already degraded and the color developing ability has been lost);

and then the diazo color-developing layer B-1 is irradiated with light of 360±20 nm whereby the diasonium salt compound contained in the diazo color-developing layer B-1 is degraded;

and finally, sufficient heat for the color development of the leuco color-developing layer A is applied to cause color development (during which the diazo color-developing layer B-2 and the diazo-color developing layer B-1 are also strongly heated, but do not cause further color development since the diazonium salt compounds have been already degraded and the color developing ability has been lost).

In multicolor heat-sensitive recording layers, it is possible to perform a full-color image recording when three primary colors of the subtractive color mixing, namely yellow, magenta and cyan, are selected as the color hues that the respective heat-sensitive recording layers can develop.

Such multicolor heat-sensitive recording material is described in detail in paragraphs [0031] to [0219] of JP-A No. 2004-243668, the disclosure of which is incorporated herein by reference.

In the heat-sensitive recording material of the invention, one or more heat-sensitive recording layers are provided on a support. In a preferable embodiment, a light-transmittance adjusting layer, a protective layer, and an intermediate layer are also provided.

Light-Transmittance Adjusting Layer

The light-transmittance adjusting layer comprises an ultraviolet absorber precursor. Since the ultraviolet absorber precursor does not function as an ultraviolet absorber prior to the irradiation with a light of the wavelength region required for fixation, the light-transmittance adjusting layer has a high light transmittance and sufficiently transmits the light of the wavelength region required for fixation at the fixation of the photo-fixable heat-sensitive recording layer. Since the ultraviolet absorber precursor has a high light transmittance in the visible region, the fixation of the heat-sensitive recording layer is not inhibited. The ultraviolet absorber precursor is preferably contained in microcapsules.

Compounds contained in the light-transmittance adjusting layer may be selected from the compounds described in JP-A No. 9-1928, the disclosure of which is incorporated herein by reference.

After the irradiation with the light of the wavelength region required for the fixation of the heat-sensitive recording layer, the ultraviolet absorber precursor is converted to a fuinctional ultraviolet absorber by a reaction caused by light or heat. The ultraviolet absorber absorbs most of the light in the ultraviolet wavelength region required for the fixation, whereby the transmittance of the heat-sensitive recording layer is decreased and the light fastness of the heat-sensitive recording material is improved. The transmittance for the visible light remains substantially unchanged because the ultraviolet absorber does not absorb the visible light.

The heat-sensitive recording material may comprise at least one light-transmittance adjusting layer. In a preferable embodiment, the light-transmittance adjusting layer is provided between the heat-sensitive recording layer and the outermost protective layer. In another embodiment, the light-transmittance adjusting layer also works as a protective layer. The characteristics of the light-transmittance adjusting layer may be arbitrarily selected according to the characteristics of the heat-sensitive recording layer.

The coating liquid for forming the light-transmittance adjusting layer (light-transmittance adjusting layer coating liquid) can be obtained by mixing the components explained in the foregoing. The light-transmittance adjusting layer can be formed by coating the coating liquid by a known coating method such as methods using bar coaters, air knife coaters, blade coaters or curtain coaters. The light-transmittance adjusting layer may be coated simultaneously with the heat-sensitive recording layer, or coated and formed on the heat-sensitive recording layer after the heat-sensitive recording layer coating liquid is coated and dried. The coating amount of the solid of the light-transmittance adjusting layer is preferably within a range of 0.8 to 4.0 g/m².

Intermediate Layer

When the heat-sensitive recording material of the invention comprises a lamination of the heat-sensitive recording layer of the invention (e.g., the leuco color developing layer according to the invention) and a heat-sensitive recording layer of a different color hue (e.g., a diazo color developing layer), an intermediate layer may be provided between the heat-sensitive recording layers so as to prevent color mixing between the heat-sensitive recording layers. The intermediate layer is not particularly limited and may be formed using a water-soluble polymer compound or the like. Examples of the water-soluble polymer compound include polyvinyl alcohol, modified polyvinyl alcohol, methyl cellulose, sodium polystyrenesulfonate, a styrene-maleic acid copolymer, gelatin, a gelatin derivative, polyethylene glycol, and a polyethylene glycol derivative.

The intermediate layer preferably comprises the above-described inorganic layer-structured compound. When the intermediate layer comprises the inorganic layer-structured compound, the material transfer between the layers is inhibited and prevented, thereby preventing color mixing. Further, since the intermediate layer suppresses supply of oxygen, the pre-use storability of the recording material and the storability of the color image are improved.

Protective Layer

The heat-sensitive recording material of the invention may further comprise a protective layer provided on the heat-sensitive recording layer according to the necessity. In an embodiment, two or more protective layers are provided to form a lamination, according to the necessity. Examples of the binder usable in the protective layer include modified polyvinyl alcohols (e.g., silanol-modified polyvinyl alcohol, (long-chain alkylether)-modified polyvinyl alcohol, acetacetyl-modified polyvinyl alcohol, and carboxy-modified polyvinyl alcohol), a polyvinyl alcohol silicone-modified polymer, carboxymethyl cellulose, and hydroxyethyl cellulose. Only one binder may be used, or two or more binders may be used.

The protective layer preferably comprises a pigment. Such a pigment is preferably inorganic ultra fine particles, whose examples include colloidal silica, zirconium oxide, barium sulfate, aluminum oxide (alumina), zinc oxide, magnesium oxide, calcium oxide, cerium oxide and titanium oxide. Only one pigment may be used, or two or more pigments may be used in combination.

In a preferable embodiment, a protective layer coating liquid containing silanol-modified polyvinyl alcohol and colloidal silica is coated on the heat-sensitive recording layer or the like by an apparatus such as a bar coater, an air knife coater, a blade coater or a curtain coater, and then the protective layer coating liquid is dried to form a protective layer. The protective layer may be coated simultaneously with the heat-sensitive recording layer by a simultaneous multi-layer coating method, or may be coated on the heat-sensitive recording layer after the heat-sensitive recording layer is coated and dried. The protective layer preferably has a solid coating amount of 0.1 to 3 g/m², more preferably 0.3 to 2.0 g/m². An excessively large coating amount significantly decreases the thermal sensitivity while an excessively small coating amount cannot provide functions (friction resistance, lubricating property, scratch resistance and the like) as a protective layer. The heat-sensitive recording material may be subjected to a calendering treatment after the application of the protective layer as necessary.

Support

Examples of the support usable in the invention include a polyester film such as a polyethylene terephthalate film or a polybutylene terephthalate film, a cellulose derivative film such as a cellulose triacetate film, a polyolefin film such as a polystyrene film, a polypropylene film or a polyethylene film, a plastic film such as a polyimide film, a polyvinyl chloride film, a polyvinylidene chloride film, a polyacrylate copolymer film or a polycarbonate-film, paper, synthetic paper and paper having a plastic film. The support is preferably paper having a plastic film. The support may be transparent or opaque. Only a single support may be used, or two or more supports may be used in combination.

The support having a plastic film is preferably a base paper having a thermoplastic resin layer on the side to be provided with the recording layer, or a base paper having thermoplastic resin layers on both sides. Such a base having one or more resin layers may be formed, for example by (1) coating a thermoplastic resin on a base paper by melt extrusion, (2) coating a thermoplastic resin layer on a base paper by melt extrusion, and then coating a gas barrier layer thereon, (3) adhering a plastic film of a low oxygen permeability to a base paper, (4) adhering a plastic film to a base paper and then providing a thermoplastic layer by melt extrusion, or (5) coating a thermoplastic resin on a base paper by melt extrusion and then adhering a plastic film thereto.

Examples of the thermoplastic resin to be coated on the base paper by melt extrusion include olefin polymers (e.g., homopolymers of a-olefins such as polyethylene and polypropylene and mixtures of such polymers), and random copolymer of ethylene and vinyl alcohol. The polyethylene may be, for example, low density polyethylene (LDPE), high density polyethylene (HDPE), or linear low density polyethylene (L-LDPE).

The method of adhering the plastic film to the base paper is not particularly limited, and may be suitably selected from known lamination methods such as those described in Shin-laminate Kako Binran (New lamination work handbook) (edited by Kako Gijutsu Kenkyuukai, the disclosure of which is incorporated herein by reference). Preferable examples thereof include so-called dry lamination, solventless dry lamination, dry lamination utilizing an electron-beam-curable resin or an ultraviolet-curable resin, or hot dry lamination.

Among the supports mentioned in the foregoing, supports comprising a base paper containing natural pulp as the main component and olefin polymer(s) coated on both sides of the base paper, are particularly preferable.

### EXAMPLES

The invention will be described more specifically below by way of Examples, however the invention is not limited to the following Examples as far as the spirit of the invention is not lost. Unless otherwise indicated, “part” and “%” are based on mass.

### Example 1

(1) Preparation of Gelatin Solution

<Preparation of Phthalated Gelatin Solution>

32 parts of phthalated gelatin (trade name: MGP gelatin, manufactured by Nippi Collagen) and 0.914 part of 1,2-benzothiazoline-3-one (3.5% methanol solution, manufactured by Dito Chemix) were added to 367.1 parts of ion-exchanged water, and dissolved at 40° C. to obtain a phthalated gelatin solution.

<Preparation of Alkali-Treated Gelatin Solution>

25.5 parts of alkali-treated low-ion gelatin (trade name: # 750 gelatin, manufactured by Nitta Gelatin Inc.), 0.729 part of 1,2-benzothioazoline-3-one (3.5% methanol solution, manufactured by Dito Chemix), and 0.153 part of calcium hydroxide were added to 143.6 parts of ion-exchanged water, and dissolved at 50° C. to obtain an alkali-treated gelatin solution for emulsion preparation.

(2) Preparation of First Heat-Sensitive Recording Layer Liquid

<Preparation of Solution (a) of Microcapsules Containing Diazonium Salt Compound>

4.4 parts of the following diazonium salt compound (A) (having a maximum absorption wavelength of 420 nm), 4.8 parts of monoisopropylbiphenyl, 4.8 parts of diphenyl phthalate and 0.4 part of diphenyl-(2,4,6-trimethylbenzoyl)phosphine oxide (trade name: LUSILINE TPO, manufactured by BASF Japan) were added to 16.1 parts of ethyl acetate, and uniformly dissolved by being heated to 40° C. 8.6 parts of a mixture of a xylylene diisocyanate-trimethylolpropane adduct and a xylylene diisocyanate-bisphenol A adduct (trade name: TAKENETE D119N (50% ethyl acetate solution), manufactured by Mitsuitakeda Chemical) as a capsule wall material was added thereto, and the mixture was stirred to form a mixed liquid (I).

Separately, 16.3 parts of ion-exchanged water and 0.34 part of SCRAPH AG-8 (50%, manufactured by Nippon Fine Chemical Co., Ltd) were added to 58.6 of the phthalated gelatin solution to form a mixed liquid (II).

The mixed liquid (I) was added to the mixed liquid (II), and the resultant mixture was emulsified at 40° C. with a homogenizer (manufactured by Nippon Seiki Seisakusyo). 20 parts of water was added to the emulsion obtained, and the emulsion was made homogenous. Thereafter, the emulsion was stirred at 40° C., thereby allowing the capsule-forming reaction to proceed while removing ethyl acetate. Thereafter, 4.1 parts of ion-exchange resin AMBERLITE IRA68 (manufactured by Organo) and 8.2 parts of AMBERLITE IRC50 (manufactured by Organo) were added to the emulsion, and the emulsion was further stirred. Thereafter, the ion-exchange resins were filtered out, and the concentration was adjusted such that the solid concentration of the microcapsule liquid became 20%.

In this way, a liquid (a) of microcapsules containing the diazonium salt compound was obtained. The particle diameter of the resultant microcapsule was measured as described below, and found to be 0.461 μm in terms of the median diameter.

Specifically, the particle diameter was measured with a laser diffraction/scattering-type particle size distribution measuring apparatus (trade name; LA700, manufactured by HORIBA). Prior to measurement, the microcapsule liquid at 40° C. was added such that the transmittance of the light for measurement was 69 to 74%, and then the microcapsule liquid was stirred and irradiated with ultrasound for 2 minutes in this state, and then the measurement of the volume-based median diameter was conducted. 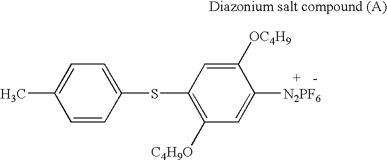
<Preparation of Coupler Compound Emulsion (a)>

9.9 parts of the following coupler compound (C), 9.9 parts of polyphenylguanidine (manufactured by Hodogawa Chemical Co., Ltd), 20.8 parts of 4,4′-(m-phenylenediisopropylidene)diphenol (trade name: bisphenol M, manufactured by Mitsui Petrochemical Industries, Ltd.), 3.3 parts of 3,3,3′,3′-tetramethyl-5,5′,6,6′-tetra(1-propyloxy)-1,1′-spirobisindane (manufactured by Sankyo Chemical Industries, Ltd.), 13.6 parts of 4-(2-ethylhexyloxy)benzenesulfonic acid amide (manufactured by Manack), 6.8 parts of 4-n-pentyloxybenzenesulfonic acid amide (manufactured by Manack), and 4.2 parts of calcium dodecylbenzenesulfonate (trade name: PIONINE A-41-C, 70% methanol solution, manufactured by Takemoto Oil & Fat Co., Ltd.) were dissolved in 33.0 parts of ethyl acetate to obtain a mixed liquid (III).

Separately, 107.3 parts of ion-exchanged water was mixed with 206.3 parts of the aforementioned alkali-treated gelatin solution to obtain a mixed liquid (IV).

The mixed liquid (III) was added to the resultant mixed liquid (IV), and the mixture was emulsified at 40° C. with a homogenizer (manufactured by Nippon Seiki Seisakusyo). The resultant coupler compound emulsion was heated under reduced pressure to remove ethyl acetate, and the concentration was regulated to give a solid concentration of 26.5%.

Further, 9 parts of SN-307 (48% solution, manufactured by Sumika APS Latex) having a concentration adjusted to 26.5% was added to 100 parts of the coupler compound emulsion, and this mixture was uniformly stirred to obtain a coupler compound emulsion (a). 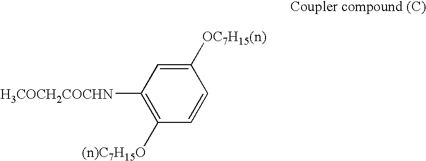
<Preparation of First Heat-Sensitive Recording Layer Coating Liquid (a)>

The aforementioned liquid (a) of microcapsules containing the diazonium salt compound and the aforementioned coupler compound emulsion (a) were mixed to give a mass ratio of the coupler compound to the diazonium salt compound of 2.2/1, thereby forming a first heat-sensitive recording layer coating liquid (a).

(3) Preparation of Second Heat-Sensitive Recording Layer Liquid

<Preparation of Liquid (b) of Microcapsules Containing Diazonium Salt Compound>

0.525 part of the following diazonium salt compound (D), 0.88 part of isopropylbisphenyl, 0.23 part of tricresyl phosphate, 0.30 part of dibutyl sulfate, 0.106 part of 2,4,6-trimethylbenzoylphenylphosphinic acid ethyl ester (trade name: LUSILINE TPO-L, manufactured by BASF), and 0.01 part of calcium dodecylbenzenesulfonate (trade name: PIONINE A-41-C (70% methanol solution), manufactured by Takemoto Oil & Fat Co., Ltd) were added to 1.77 parts of ethyl acetate, and heated to be dissolved uniformly. 1.50 parts of a xylylene diisocyanate-trimethylolpropane adduct (trade name: TAKENATE D110N (75% ethyl acetate solution), manufactured by Takeda Chemical Industries, Ltd.) as a capsule wall material was added to this mixture liquid, and the mixture was uniformly stirred to obtain a mixed liquid (V).

Separately, 3.15 parts of ion-exchanged water and 0.072 part of sodium dodecylbenzenesulfonate 25% aqueous solution (trade name: NEOPELEX G-15, manufactured by Kao Corporation) were added to and mixed with 8.25 parts of the aforementioned phtahlated gelatin aqueous solution to obtain a mixed liquid (VI).

The mixed liquid (V) was added to the mixed liquid (VI), and the mixture was emulsified at 30° C. with a homogenizer (manufacture by Nippon Seiki Seisakusyo). 4.0 parts of water was added to the resultant emulsion, and the emulsion was made homogenous. The emulsion was then stirred at 40° C., thereby allowing the capsule-forming reaction to proceed for 2 hours while removing ethyl acetate. Thereafter, 0.038 part of 1,2-benzothiazoline-3-one (3.5% methanol solution, manufactured by Daito Chemical Industries, Ltd.) was added. Then, 0.53 part of ion-exchange resin AMBERLITE IRA67 (manufactured by Organo) and 1.07 parts of SWA 100-HG (manufactured by Organo) were added, and the mixture was further stirred for 45 minutes. Thereafter, the ion-exchange resins were removed by filtration, and the concentration was adjusted to give a solid concentration of 18.5%, thereby forming a liquid (b) of microcapsules containing the diazonium salt compound.

The particle diameter of the resultant microcapsule liquid was measured with a laser diffraction/scattering-type particle size distribution measuring apparatus LA700 (manufactured by HORIBA) in the same manner as described above, and was found to be 0.57 μm in terms of the median diameter. 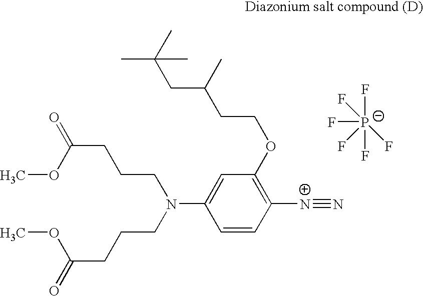
<Preparation of Coupler Compound Emulsion (b)>

0.70 part of the following coupler compound (E), 1.56 parts of triphenylguanidine (manufactured by Hodogaya Chemical Co., Ltd.), 1.56 parts of 4,4′-(m-phenylenediisopropylidene)diphenol (trade name: bisphenol M, manufactured by Mitsui Petrochemical Industries, Ltd.), 1.56 parts of 1,1-(p-hydroxyphenyl)-2-ethylhexane, 0.39 part of 3,3,3′,3′-tetramethyl-5,5′,6,6′-tetra(1-propyloxy)-1,1′-spirobisindane, 0.39 part of the following compound (F), 0.186 part of tricresyl phosphate, 0.094 part of diethyl maleate, and 0.447 part of calcium dodecybenzenesulfonate (trade name: PIONINE A-41 -C (70% methanol solution), manufactured by Takemoto Oil & Fat Co., Ltd.) were dissolved in 4.10 parts of ethyl acetate to obtain a mixed liquid (VII).

Separately, 16.1 parts of ion-exchanged water, and 0.329 part of 1,2-benzothiazoline-3-one (3.5% methanol solution, manufactured by Daito Chemical Industries, Ltd.) were mixed with 19.21 parts of the alkali-treated gelatin aqueous solution to obtain a mixed liquid (VIII).

The mixed liquid (VII) was added to the mixed liquid (VIII), and the mixture was emulsified at 40° C. with a homogenizer (manufactured by Nippon Seiki Seisakusyo). The resultant coupler compound emulsion was heated under reduced pressure to remove ethyl acetate, and the concentration was regulated to give a solid concentration of 24.5%, thereby forming a coupler compound emulsion (b).

The particle diameter of the coupler compound emulsion obtained was measured with a laser diffraction/scattering-type particle size distribution measuring apparatus LA700 (manufactured by HORIBA) in the same manner as described above, and was found to be 0.26 μm in terms of the median diameter. 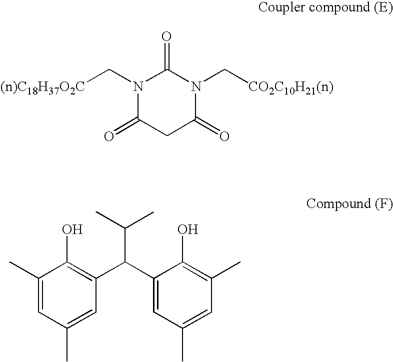
<Preparation of Second Heat-Sensitive Recording Layer Coating Liquid (b)>

The aforementioned liquid (b) of microcapsules containing the diazonium salt compound and the aforementioned coupler compound emulsion (b) were mixed such that the weight ratio of the coupler compound to the diazo compound was 1.9/1. Further, 0.21 part of an aqueous solution (5%) of polystyrenesulfonic acid (partially neutralized with potassium hydroxide) was mixed with 10 parts of the microcapsule liquid to obtain a second heat-sensitive recording layer coating liquid (b).

(4) Preparation of Third Heat-Sensitive Recording Layer Liquid

<Preparation of Liquid (c) of Microcapsules Containing Electron-Donating Colorless Dye-Precursor>

7.7 parts of the following electron-donating colorless dye-precursor (H), 6.0 parts of an edible rapeseed oil, 2.4 parts of Light Ester TNP (manufactured by Kyoei Yushikagaki), 4.9 parts of IRGAPERM2140 (manufactured by Ciba Specialty Chemicals), and 2.7 parts of 1,1,3,3-tris(2-methyl-4-hydroxy-5-t-butylphenylbutane) (trade name: ADECACRUISE DH-37, manufactured by Asahi Denka Kogyo K.K.) were added to 20 parts of ethyl acetate, and heated to be dissolved uniformly.

7.0 parts of a xylylene diisocyanate-trimethylolpropane adduct (trade name: TAKENATE D110N (75% ethyl acetate solution), manufactured by Mitsuitakeda Chemical) as a capsule wall material, 7.0 parts of polymethylenepolyphenyl polyisocyanate (trade name: MILLIONATE MR-200, manufactured by Nippon Polyurethane Industry Co., Ltd.), and 2.3 parts of a mixture (M)(50% ethyl acetate solution) obtained by the addition of the following compound (L) to xylylene diisocyanate (the ratio of compound (L) to xylylene diisocyanate being 6/1 by mol) were added to the above mixture liquid, and the obtained mixture was stirred uniformly to form a mixed liquid (IX).

Separately, 10 parts of ion-exchanged water, 0.19 part of SCRAPH AG-8 (50%, manufactured by Nippon Fine Chemical Co., Ltd), and 0.42 part of sodium dodecylbenzenesulfonate (10% aqueous solution) were added to and mixed with 28.8 parts of the aforementioned phthalated gelatin solution, to obtain a mixed liquid (X).

The mixed liquid (IX) was added to the mixed liquid (X), and the mixture was emulsified at 40° C. with a homogenizer (manufactured by Nippon Seiki Seisakusyo). 50 parts of water and 0.13 part of tetraethylenepentamine were added to the resultant emulsion, and the emulsion was made homogenous. The emulsion was stirred at 65° C., thereby allowing the capsule-forming reaction to proceed while removing ethyl acetate. Then, the concentration was adjusted such that the solid concentration of the microcapsule liquid became 33%, thereby forming a microcapsule liquid.

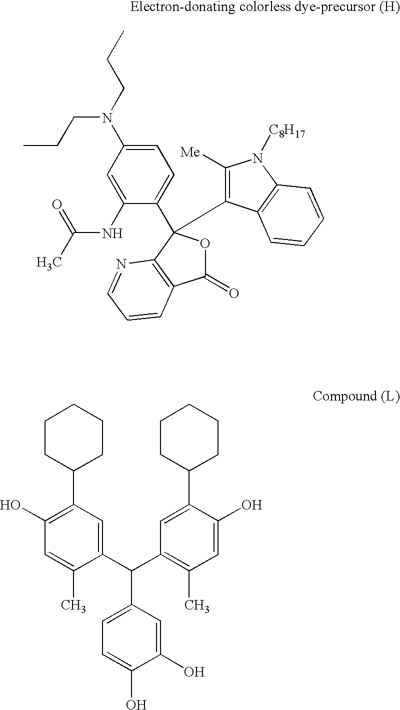

The particle diameter of the resultant microcapsule solution was measured with a laser diffraction/scattering-type particle size distribution measuring apparatus LA700 (manufactured by HORIBA) in the same manner as described above, and was found to be 1.01 μm in terms of the median diameter.

Further, 3.7 parts of a 25% aqueous solution of sodium dodecylbenzenesulfonate (trade name: NEOPLEX F-25, manufactured by Kao Corporation) and 3.2 parts of 4,4′-bistriazinylaminostilbene-2,2′-disulfone derivative (trade name: KAYCALL BXNL, manufactured by Nippon Soda Co., Ltd.) were added to 100 parts of the microcapsule liquid, and the mixture was uniformly stirred to obtain a liquid (c) of microcapsules containing the electron-donating colorless dye-precursor.

<Preparation of Electron-Receiving Compound Dispersion Liquid (c)>

30.1 parts of ion-exchanged water, 15 parts of 4,4′-(p-phenylenediisopropylidene)diphenol (trade name: bisphenol P, manufactured by Mitsui Petrochemical Industries, Ltd.), and 3.8 parts of a 2% aqueous sodium 2-ethylhexylsuccinate solution were added to 11.3 parts of the aforementioned phthalated gelatin solution, and the mixture was dispersed with a ball mill overnight to obtain a dispersion liquid. The solid concentration of this dispersion liquid was 26.6%. 45.2 parts of the aforementioned alkali-treated gelatin solution was added to 100 parts of the dispersion liquid, and the dispersion liquid was stirred for 30 minutes. Ion-exchanged water was added to the dispersion liquid such that the solid concentration of the dispersion liquid became 23.5%, thereby forming an electron-receiving compound dispersion liquid (c).

<Preparation of Third Heat-Sensitive Recording Layer Coating Liquid (c)>

The liquid (c) of microcapsules containing the electron-donating dye-precursor and the electron-receiving compound dispersion liquid (c) were mixed such that the mass ratio of the electron-receiving compound to the electron-donating dye-precursor was 10/1, thereby forming a third heat-sensitive recording layer coating liquid (c).

(5) Preparation of Coating Liquid for each of the Layers other than the Color-Developing Layer

<Preparation of Intermediate Layer Coating Liquid>

100.0 parts of alkali-treated low ion gelatin (trade name: #750 gelatin, manufactured by Nitta Gelatin Inc.), 2.86 parts of 1,2-benzothiazoline-3-one (3.5% methanol solution, manufactured by Dito Chemix), and 0.5 part of calcium hydroxide were mixed with 521.643 parts of ion-exchanged water, and dissolved at 50° C. to obtain a gelatin aqueous solution for an intermediate layer.

10.0 parts of the gelatin aqueous solution for an intermediate layer, 0.05 part of sodium 4-[(4-nonylphenoxy)trioxyethylene]butylsulfonate (2.0% aqueous solution, manufactured by Sankyo Chemical Industries, Ltd.), 1.5 parts of boric acid (4.0% aqueous solution), 0.19 part of a polystyrenesulfonic acid (partially neutralized with potassium hydroxide) aqueous solution (5%), 3.42 parts of a 4% aqueous solution of the following compound (J), 1.13 parts of a 4% aqueous solution of the following compound (J′), and 0.67 part of ion-exchanged water were mixed to form an intermediate layer coating liquid. 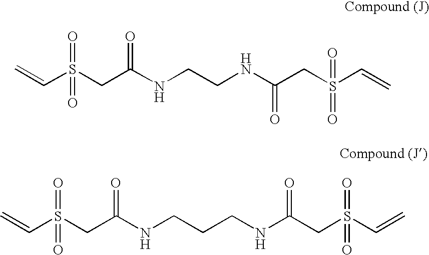
<Preparation of Light-Transmittance Adjusting Layer Coating Liquid>
(1) Preparation of Ultraviolet Absorber Precursor Microcapsule Liquid

14.5 parts of [2-allyl-6-(2H-benzotriazol-2-yl)-4-t-octylphenyl]benzenesulfonate as an ultraviolet absorber precursor, 5.0 parts of 2,5-di(t-octyl)hydroquinone, 1.9 parts of tricresyl phosphate, 5.7 parts of α-methylstyrene dimer (trade name: MSD-100, manufactured by Mitsui Chemicals, Inc.), and 0.4 part of calcium dodecylbenzenesulfonate (trade name: PIONINE A-41-C (70% methanol solution), manufactured by Takemoto Oil & Fat Co., Ltd.) were uniformly dissolved in 71 parts of ethyl acetate.

54.7 parts of a xylylene diisocyanate/trimethylolpropane adduct (trade name: TAKENATE D110N(75% ethyl acetate solution), manufactured by Mitsuitakeda Chemical) as a capsule wall material was added to the resultant mixed solution, and the obtained mixture was uniformly stirred to form an ultraviolet absorber precursor mixture liquid.

Separately, 8.9 parts of a 30% aqueous phosphoric acid solution and 532.6 parts of ion-exchanged water were mixed with 52 parts of polyvinyl alcohol modified with itaconic acid (trade name: KL-318, manufactured by Kuraray Co., Ltd.) to prepare an aqueous PVA solution for an ultraviolet absorber precursor microcapsule liquid.

The ultraviolet absorber precursor mixture liquid was added to 516.06 parts of the aqueous PVA solution for an ultraviolet absorber precursor microcapsule liquid, and the mixture was emulsified at 20° C. with a homogenizer (manufactured by Nippon Seiki Seisakusyo). 254.1 parts of ion-exchanged water was added to the obtained emulsion, and the emulsion was made homogenous. Then, the emulsion was stirred at 40° C., thereby allowing the capsule-forming reaction to proceed for 3 hours. Thereafter, 94.3 parts of ion-exchange resin AMBERLITE MB-3 (manufactured by Organo) was added, and the mixture was further stirred for 1 hour. Thereafter, the ion-exchange resin was removed by filtration, and the concentration was adjusted to give a solid concentration of 13.5%, thereby forming a microcapsule liquid. Then, 2.416 parts of carboxy-modified styrene-butadiene latex (trade name: SN-307, (48% aqueous solution), manufactured by Sumitomo Nogatack) and 39.5 parts of ion-exchanged water were mixed with 859.1 parts of the microcapsule liquid to form an ultraviolet absorber precursor microcapsule liquid.

(2) Preparation of Light-Transmittance Adjusting Layer Coating Liquid

1000 parts of the ultraviolet absorber precursor microcapsule liquid, 5.2 parts of a fluorine-based surfactant (trade name: MEGAFAX F-120, 5% aqueous solution, manufactured by Dainippon Ink and Chemicals, Incorporated), 7.75 parts of a 4% aqueous sodium hydroxide solution, and 73.39 parts of sodium (4-nonylphenoxytrioxyethylene)butylsulfonate (2.0% aqueous solution, manufactured by Sankyo Chemical Industries, Ltd.) were mixed to form a light transmittance-adjusting layer coating liquid.

<Preparation of Protective Layer Coating Liquid>

(1) Preparation of Polyvinyl Alcohol Solution for Protective Layer

160 parts of a vinyl alcohol-alkyl vinyl ether copolymer (trade name: EP-130, manufactured by Denki Kagaku Kogyo Kabushiki Kaisha) and 8.74 parts of a mixture solution of sodium alkylsulfonate and polyoxyethylene alkyl ether phosphoric ester (trade name: NEOSCORE CM-57, (54% aqueous solution), manufactured by Toho Chemical Industry Co., Ltd.) were mixed with 3832 parts of ion-exchanged water, and dissolved at 90° C. for 1 hour to form a uniform polyvinyl alcohol solution for a protective layer.

2) Preparation of Pigment Dispersion Liquidfor Protective Layer

0.2 part of nonion special polycarboxylic acid-type polymer active agent (trade name: POISE 532A (40% aqueous solution), manufactured by Kao Corporation) and 8 parts of barium sulfate (trade name: BF-21F, barium sulfate content 93% or more, manufactured by Sakai Chemical Industry Co., Ltd.) were mixed with 11.8 parts of ion-exchanged water, and dispersed with a Dino mill to prepare a dispersion liquid (K).

8.1 parts of colloidal silica (trade name: SNOWTEX 0 (20% aqueous dispersion), manufactured by Nissan Chemical Industries, Ltd.) was added to 45.6 parts of dispersion liquid (K) to form a pigment dispersion liquid for a protective layer.

(3) Preparation of Matting Agent Dispersion Liquid for a Protective Layer

3.81 parts of a 1,2-benzisothiazoline-3(2H)-one aqueous dispersion (trade name: PROXEL B.D, manufactured by I.C.I), and 1976.19 parts of ion-exchanged water were mixed with 220 parts of wheat starch (trade name: Wheat Starch S, manufactured by Shinshin Shokuryo Kogyo) to form a uniform dispersion, whereby a matting agent dispersion liquid for a protective layer was obtained.

(4) Preparation of Protective Layer Coating Liquid

40 parts of a fluorine-based surfactant (trade name: MEGAFAX F-120, 5% aqueous solution, manufactured by Dainippon Ink and Chemicals, Incorporated), 50 parts of sodium (4-nonylphenoxytrioxyethylene)butylsulfonate (2.0% aqueous solution, manufactured by Sankyo Chemical Industries, Ltd.), 49.87 parts of the pigment dispersion liquid for a protective layer, 16.65 parts of the matting agent dispersion liquid for a protective layer, and 48.7 parts of a zinc stearate dispersion liquid (trade name: HYDRIN F 115, 20.5% aqueous solution, manufactured by Chukyo Oil & Fat Co., Ltd.) were uniformly mixed with 1000 parts of the polyvinyl alcohol solution for a protective layer, thereby forming a protective layer coating liquid.

(6) Preparation of Support with Undercoat Layer

<Preparation of Undercoat Layer Coating Liquid>

40 parts of enzymatically-degraded gelatin (average molecular weight: 10,000, viscosity according to the PAGI method: 15 mP, jelly strength according to the PAGI method: 20 g) was added to 60 parts of ion-exchanged water, and the mixture was stirred to dissolve the gelatin at 40° C., thereby forming an aqueous gelatin solution for an undercoat layer.

Separately, 8 parts of water-swelling synthetic mica (aspect ratio: 1000, trade name: SOMASHIF ME 100, manufactured by Coop Chemical) and 92 parts of water were mixed, and the mixture was subjected to wet-dispersing with a viscomill, thereby forming a mica dispersion liquid having an average particle diameter of 2.0 μm. Water was added to this mica dispersion liquid so that a uniform mixture having a mica concentration of 5% was obtained.

The desired mica dispersion liquid was prepared in this way.

Then, 120 parts of water and 556 parts of methanol were added to 100 parts of the 40% aqueous gelatin solution for an undercoat layer having a temperature of 40° C. The resultant mixture was sufficiently stirred. Then, 208 parts of the 5% mica dispersion liquid was added thereto, and the mixture was further stirred sufficiently. Thereafter, 9.8 parts of a 1.66% polyethylene oxide-based surfactant was added thereto.

Subsequently, the liquid temperature was maintained in the range of 35° C. to 40° C., and 7.3 parts of a gelatin hardener (an epoxy compound; trade name: DENACOL EX80, manufactured by Nagase Chemicals Ltd.) was added thereto, thus forming an undercoat layer coating liquid (5.7%).

<Preparation of Support with Undercoat Layer>

A timber pulp consisting of 50 parts of LBPS and 50 parts of LBPK was beaten to a Canadian freeness of 300 cc with a double disc refiner. Then, 0.5 part of epoxydized behenic acid amide, 1.0 part of anionic polyacrylamide, 1.0 part of aluminum sulfate, 0.1 part of polyamide polyamine epichlorohydrin, and 0.5 part of cationic polyacrylamide were added, each amount representing the bone-dry weight ratio relative to the pulp. Then, the mixture was used for paper making with a fourdrinier, thereby forming a raw paper with a basic weight of 114 g/m². The raw paper was subjected to calender treatment, whereby the thickness was adjusted to 100 μm.

Then, both sides of the raw paper were subjected to corona discharge treatment. Then, polyethylene was extruded with a melt extruder, thus being coated on the raw paper to a resin thickness of 36 μm. The resin layer obtained had a matte surface (this side is hereinafter referred to as “back side”). Then, a polyethylene containing 10% of anatase-type titanium dioxide and a trace amount of ultramarine was coated on the side opposite to the side having the resin layer formed thereon, by being extruded to a resin thickness of 50 μm with a melt extruder, whereby a resin layer having a glossy surface (this side is hereinafter referred to as “front side”) was formed. The resin layer surface on the back side was subjected to corona discharge treatment. An antistatic agent [aluminum oxide (trade name: ALUMINA SOL 100, manufactured by Nissan Chemical Industries, Ltd.)/silicon dioxide (trade name: SNOWTEX O, manufactured by Nissan Chemical Industries)=1/2 [mass ratio]] was dispersed in water, and the dispersion liquid was coated on the paper such that the dry coating amount of the antistatic agent was 0.2 g/m². Then, the resin layer surface on the front side was subjected to corona discharge treatment, and the undercoat layer coating liquid was coated to give a mica coating amount of 0.26 g/m², whereby a support with an undercoat layer was obtained.

(7) Preparation of Heat-Sensitive Recording Material

The seven layers (the third heat-sensitive recording layer coating liquid (c), the intermediate layer coating liquid, the second heat-sensitive recording layer coating liquid (b), the intermediate layer coating liquid, the first heat-sensitive recording layer coating liquid (a), the light transmittance-adjusting layer coating liquid, and the protective layer coating liquid in this order from the support side) were simultaneously coated continuously on the support obtained above (the support having undercoat layers formed thereon), and the layers were dried under the environmental condition of a temperature of 30° C. and a humidity of 30%, and then under the environmental condition of a temperature of 40° C. and a humidity of 30%, whereby a multicolor heat-sensitive recording material (T-1) of the invention was obtained.

During the coating, the coating amount of the first heat-sensitive recording layer coating liquid (a) was such an amount that the coating amount of the dizonium salt compound (A) contained in the coating liquid was 0.078 g/m² in terms of a solid coating amount; the coating amount of the second heat-sensitive recording layer coating liquid (b) was such an amount that the coating amount of the diazonium salt compound (D) contained in the coating liquid was 0.206 g/m² in terms of a solid coating amount; and the coating amount of the third heat-sensitive recording layer coating liquid (c) was such an amount that the coating amount of the electron-donating colorless dye-precursor (H) contained in the coating liquid was 0.355 g/m² in terms of a solid coating amount.

In addition, the coating amount of the intermediate layer coating liquid disposed between the first heat-sensitive recording layer coating liquid (a) and the second heat-sensitive recording layer coating liquid (b) was such an amount as to give a solid coating amount of 2.39 g/m², and the coating amount of the intermediate layer coating liquid disposed between the second heat-sensitive recording layer coating liquid (b) and the third heat-sensitive recording layer coating liquid (c) was such an amount as to give a solid coating amount of 3.34 g/m². The coating amount of the light transmittance-adjusting layer coating liquid was such an amount as to give a solid coating amount of 2.35 g/m², and the coating amount of the protective layer was such an amount as to give a solid coating amount of 1.39 g/M².

### Example 2

A multicolor heat-sensitive recording material (T-2) of the invention was prepared in the same manner as in Example 1 except that the edible rapeseed oil used in the preparation of the liquid (c) of microcapsules containing the electron-donating colorless dye-precursor was replaced with an edible sunflower oil, and the particle diameter of the microcapsule liquid was measured in the same manner as in Example 1.

### Example 3

A multicolor heat-sensitive recording material (T-3) of the invention was prepared in the same manner as in Example 1 except that the electron-donating colorless dye-precursor (H) used in the preparation of the liquid (c) of microcapsules containing the electron-donating colorless dye-precursor was replaced with 2-anilino-3-methyl-6-N-ethyl-N-butylaminofluoran (electron-donating colorless dye-precursor (N)), and the particle diameter of the microcapsule liquid was measured in the same manner as in Example 1.

### Comparative Example 1

A comparative multicolor heat-sensitive recording material (T-4) was prepared in the same manner as in Example 1 except that 6.0 parts of the edible rapeseed oil and 2.4 parts of Light Ester TMP used in the preparation of the liquid (c) of microcapsules containing the electron-donating colorless dye-precursor were replaced with 4.4 parts of Light Ester TMP and 4.0 parts of diisopropylbiphenyl (trade name: KMC500, manufactured by Kureha Chemical Industries Co., Ltd.), and the particle diameter of the microcapsule liquid was measured in the same manner as in Example 1.

### Comparative Example 2

A comparative multicolor heat-sensitive recording material (T-5) was prepared in the same manner as in Example 1 except that 0.19 part of SCRAPH AG-8 (50%, manufactured by Nippon Fine Chemical Co., Ltd.) and 0.42 part of sodium dodecylbenzenesulfonate (10% aqueous solution) used in the preparation of the liquid (c) of microcapsules containing the electron-donating colorless dye-precursor were replaced with 0.05 part of SCRATH AG-8 (50%, manufactured by Nippon Fine Chemical Co., Ltd.), and the particle diameter of the microcapsule liquid was measured in the same manner as in Example 1.

### Comparative Example 3

A comparative multicolor heat-sensitive recording material (T-6) was prepared in the same manner as in Example 1 except that the electron-donating colorless dye-precursor (H) used in the preparation of the liquid (c) of microcapsules containing the electron-donating colorless dye-precursor was replaced with the following compound (P), and the particle diameter of the microcapsule liquid was measured in the same manner as in Example 1.

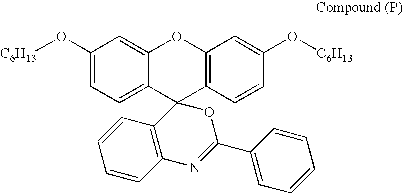

### Comparative Example 4

A liquid was prepared in the same manner as the preparation of the liquid (c) of microcapsules containing the electron-donating colorless dye-precursor in Example 1, except that 6.0 parts of the edible rapeseed oil and 2.4 parts of Light Ester TMP used in the preparation of the liquid (c) of microcapsules containing the electron-donating colorless dye-precursor were replaced with 7.1 parts of Light Ester TMP and 1.1 parts of tripalmitin glyceride. However, a microcapsule liquid could not be obtained owing to the occurrence of precipitation.

### Comparative Example 5

A liquid was prepared in the same manner as the preparation of the liquid (c) of microcapsules containing the electron-donating colorless dye-precursor in Example 1, except that 6.0 parts of the edible rapeseed oil and 2.4 parts of Light Ester TMP used in the preparation of the liquid (c) of microcapsules containing the electron-donating colorless dye-precursor were replaced with 7.1 parts of Light Ester TMP and 1.1 parts of tristearin glyceride. However, a microcapsule liquid could not be obtained owing to the occurrence of precipitation.

### Comparative Example 6

A liquid was prepared in the same manner as the preparation of the liquid (c) of microcapsules containing the electron-donating colorless dye-precursor in Example 1, except that the electron-donating colorless dye-precursor (H) used in the preparation of the liquid (c) of microcapsules containing the electron-donating colorless dye-precursor was replaced with the following compound (Q). However, a microcapsule liquid could not be obtained owing to the occurrence of precipitation.

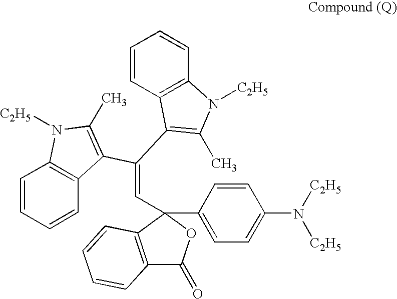

### Comparative Example 7

A liquid was prepared in the same manner as the preparation of the liquid (c) of microcapsules containing the electron-donating colorless dye-precursor in Example 1, except that the electron-donating colorless dye-precursor (H) used in the preparation of the liquid (c) of microcapsules containing the electron-donating colorless dye-precursor was replaced with the following compound (R). However, a microcapsule liquid could not be obtained owing to the occurrence of precipitation. 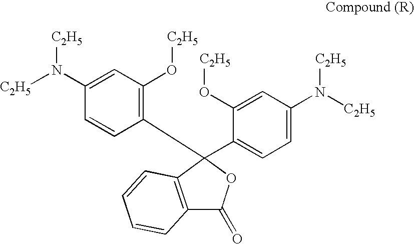
(Thermal Recording and Evaluation)

Thermal recording was performed on the multicolor heat-sensitive recording materials (T-1) to (T-6) of Examples and Comparative Examples, as described below.

Printing with a thermal head KST (manufactured by Kyocera Corporation) was performed on each multicolor heat-sensitive recording material at a recording energy of 23 mJ/mm² to form an image on the first heat-sensitive recording layer, the recording energy being adjusted by adequately selecting the electric power and pulse width applied to the thermal head. After recording, the multicolor heat-sensitive recording material was exposed for 10 seconds to light emitted by an ultraviolet lamp having an emission central wavelength of 420 nm and an output of 40 W, thus fixing the first heat-sensitive recording layer. Then, printing was performed on the multicolor heat-sensitive recording material at a recording energy of 50 mJ/mm² to form an image on the second heat-sensitive recording layer, the recording energy being adjusted by adequately selecting the electric power and pulse width applied to the thermal head. The multicolor heat-sensitive recording material after recording was exposed for 15 seconds to light emitted by an ultraviolet lamp having a emission central wavelength of 365 nm and an output of 40 W, thus fixing the second heat-sensitive recording layer. Subsequently, printing was performed on the multicolor heat-sensitive recording material at a recording energy of 90 mJ/mm² to form an image on the third heat-sensitive recording layer, the recording energy being adjusted by adequately selecting the electric power and pulse width applied to the thermal head.

The multicolor heat-sensitive recording materials after thermal recording were tested and evaluated as follows. The evaluation results are shown in Table 1 below.

-Density measurement-

The densities of the background area of each thermally-recorded heat-sensitive recording material, of the image area of the third heat-sensitive recording layer, and of the background area after being subjected to the background light-exposure test described below, were measured with X-rite 310 TR (manufactured by Nippon Heibankizai).

-Raw storability test-

Each heat-sensitive recording material before recording was sealed in an aluminum bag, and was subjected to a forced test in which the heat-sensitive recording material was stored under the environmental condition of 50° C. for 7 days. Thereafter, the material was subjected to thermal recording in a manner similar to that described above, and the optical density of the image area of the thermally-recorded third heat-sensitive recording layer was measured with X-rite 310 TR (manufactured by Nippon Heibankizai). The optical density was measured when the printing energy necessary for achieving an optical density of 1.0 in the thermally-recorded image area of the third heat-sensitive recording layer that has not been subjected to the forced test was applied to the multicolor heat-sensitive recording material that has been subjected to the forced test, and the value that is 100 times the measured density value was used as the index for evaluating the raw storability.

-Light Exposure Coloring Test of Background Part-

Each heat-sensitive recording material before recording was subjected to a light exposure coloring test for 12 days under the condition of 5,000 lux using a fluorescent lamp, and the density of the background area was measured with X-rite 310 TR (manufactured by Nippon Heibankizai).

TABLE 1

| | Particle diameter of | Recording | | | | Raw | Background |
|---|---|---|---|---|---|---|---|
| | microcapsule [μm] | material | Wall material | Mixture of triglycerides | Dye | storability | coloring |
| Example 1 | 1.01 | T-1 | Takenate D110N, Millionate | Edible rapeseed oil/Light | (H) | 80% | 0.10 |
| | | | MR-200, mixture (M) | Ester TMP | | | |
| Example 2 | 1.05 | T-2 | Takenate D110N, Millionate | Edible rapeseed oil/Light | (H) | 79% | 0.14 |
| | | | MR-200, mixture (M) | Ester TMP | | | |
| Example 3 | 1.04 | T-3 | Takenate D110N, Millionate | Edible rapeseed oil/Light | (N) | 82% | 0.15 |
| | | | MR-200, mixture (M) | Ester TMP | | | |
| Comparative | 0.9 | T-4 | Takenate D110N, Millionate | Light Ester TMP, | (H) | 52% | 0.23 |
| Example 1 | | | MR-200, mixture (M) | KMC500 | | | |
| Comparative | 4.0 | T-5 | Takenate D110N, Millionate | Edible rapeseed oil/Light | (H) | 45% | 0.51 |
| Example 2 | | | MR-200, mixture (M) | Ester TMP | | | |
| Comparative | 0.7 | T-6 | Takenate D110N, Millionate | Edible rapeseed oil/Light | (P) | 69% | 0.28 |
| Example 3 | | | MR-200, mixture (M) | Ester TMP | | | |

As shown in Table 1 above, the multicolor heat-sensitive recording materials of Examples had superior raw storability, and coloring of the background area caused by the stain developed by exposure to light could be prevented on the multicolor heat-sensitive recording materials of Examples. On the contrary, in the comparative multicolor heat-sensitive recording materials, raw storability was inferior, and the background area was also colored to deteriorate the whiteness.

Further, in addition to the vegetable oil (mixture of triglycerides) used in the above Examples according to the invention, those listed above as examples of the mixture of triglycerides are also capable of exerting the same effects as the vegetable oils used above, capable of improving the raw storability similarly, and capable of effectively preventing the coloring of the background area caused by the stain developed by exposure to light.

All publications, patent applications, and technical standards mentioned in this specification are herein incorporated by reference to the same extent as if each individual publication, patent application, or technical standard was specifically and individually indicated to be incorporated by reference.

What is claimed is:

1. A heat-sensitive recording material comprising one or more heat-sensitive recording layers on a support, wherein at least one of the heat-sensitive recording layer(s) is a leuco color-developing layer that contains a microcapsule containing an electron-donating colorless dye-precursor and a mixture of triglycerides, and a particle diameter of the microcapsule is 0.7 to 2.0 μm.

2. The heat-sensitive recording material according to claim 1, wherein a capsule wall of the microcapsule contains at least two compounds selected from the group consisting of compound (1), compound (2), and compound (3): 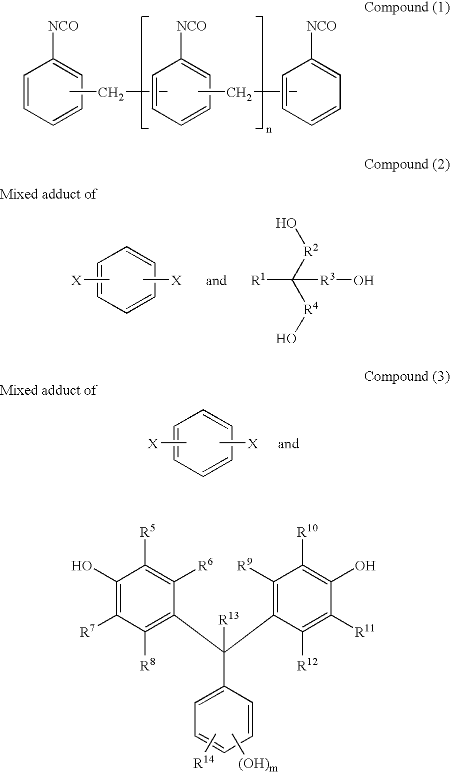
wherein in compound (1), n represents an integer of 0 to 2,
wherein in compound (2), X represents —CH₂—NCO or —NCO; two Xs may be the same as or different from each other; R¹ represents a hydrogen atom or an alkyl group having 1 to 3 carbon atoms; and R², R³, and R⁴ each independently represent an alkylene group having 1 to 3 carbon atoms, and
wherein in compound (3), X represents —CH₂—NCO or —NCO; two Xs may be the same as or different from each other; R⁵, R⁶, R⁷, R⁸, R⁹, R¹⁰, R¹¹, and R¹² each independently represent a hydrogen atom, a halogen atom, an alkyl group, an alkoxy group, an aryl group, or an aryloxy group; R¹³ represents a hydrogen atom, an alkyl group, or an aryl group; R¹⁴ represents a hydrogen atom, an alkyl group, or an alkoxy group; and m represents an integer of 1 or2.

3. The heat-sensitive recording material according to claim 1, wherein the mixture of triglycerides is a mixture of less than 20% by mass of at least one saturated fatty acid having 14 or more carbon atoms, and 20 to 60% by mass of at least one unsaturated fatty acid having 14 or more carbon atoms.

4. The heat-sensitive recording material according to claim 1, wherein the mixture of triglycerides is at least one of rapeseed oil, sunflower oil, sesame oil, and peanut oil.

5. The heat-sensitive recording material according to claim 1, wherein the electron-donating colorless dye-precursor is at least one selected from a dye represented by formula (A) and a dye represented by formula (B): 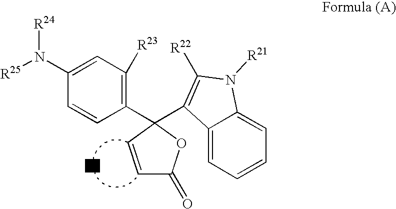
wherein in formula (A), R²¹ represents an alkyl group having 1 to 12 carbon atoms; R²² represents an alkyl group having 1 or 2 carbon atoms; R²³ represents a hydrogen atom, an alkyl group having 1 or 2 carbon atoms, an alkoxy group having 1 to 20 carbon atoms, an aryl group having 6 to 10 carbon atoms, an amido group having 2 to 12 carbon atoms, an alkylsulfonamido group having 1 to 6 carbon atoms, an arylsulfonamido group having 6 to 10 carbon atoms, an anilinocarbonamido group having 7 to 13 carbon atoms, or a halogen atom; R²⁴ and R²⁵ each independently represent an alkyl group having 1 to 8 carbon atoms; and A represents a group which, together with the lactone portion, forms an aromatic ring, 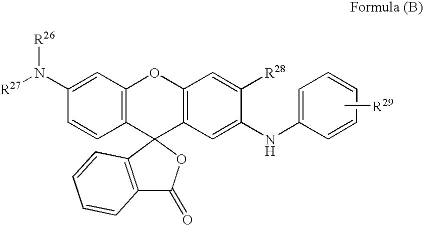
wherein in formula (B), R²⁶ represents an alkyl group having 1 to 4 carbon atoms; R²⁷ represents an alkyl group having 3 to 12 carbon atoms; and R²⁸ and R²⁹ each independently represent a hydrogen atom, a halogen atom, or an alkyl group having 1 to 3 carbon atoms.

6. The heat-sensitive recording material according to claim 1, further comprising a diazo color-developing layer containing a diazo compound and a coupler that reacts with the diazo compound under heat to develop color.

7. The heat-sensitive recording material according to claim 1, wherein the heat-sensitive recording material comprises a plurality of heat-sensitive recording layers which develop colors of respectively different hues selected from yellow, magenta, and cyan, and at least one layer of the plurality of heat-sensitive recording layers is the leuco color-developing layer.

8. The heat-sensitive recording material according to claim 1, wherein the mixture of triglycerides comprises a saturated fatty acid and an unsaturated fatty acid.

9. The heat-sensitive recording material according to claim 1, wherein the mixture of triglycerides comprise three or more fatty acids.

10. The heat-sensitive recording material according to claim 1, wherein in the leuco color-developing layer, a mass of the mixture of triglycerides is 20 to 130% of a mass of the electron-donating colorless dye-precursor.

11. The heat-sensitive recording material according to claim 1, wherein in the leuco color-developing layer, a mass of the mixture of triglycerides is 30 to 120% of a mass of the electron-donating colorless dye-precursor.

12. The heat-sensitive recording material according to claim 1, wherein the mixture of triglycerides is a vegetable oil.

13. The heat-sensitive recording material according to claim 1, wherein the mixture of triglycerides is sesame oil, safflower oil, soybean oil, sunflower oil, corn oil, cottonseed oil, rapeseed oil, peanut oil, or palm oil.

14. The heat-sensitive recording material according to claim 1, further comprising an electron-receiving compound.

15. The heat-sensitive recording material according to claim 14, wherein the electron-receiving compound is a phenol or a hydroxybenzoic ester.

16. The heat-sensitive recording material according to claim 1, wherein an amount of the electron-donating colorless dye-precursor in the leuco color-developing layer is 0.01 to 2.0 g/m² in terms of a solid coating amount.

17. The heat-sensitive recording material according to claim 1, wherein an amount of the electron-donating colorless dye-precursor in the leuco color-developing layer is 0.1 to 0.6 g/M² in terms of a solid coating amount.
